(19) United States
(12) Patent Application Publication
(10) Pub. No.: US 2025/0059071 A1
(43) Pub. Date: Feb. 20, 2025

(54) Regulation of Onsite Peroxide Generation for Improved Peroxone Advanced Oxidative Process Control

(71) Applicant: Evoqua Water Technologies LLC, Pittsburgh, PA (US)

(72) Inventors: Joshua Griffis, Ashburnam, MA (US); Simon P. Dukes, Chelmsford, MA (US); Ben Satterfield, Ayer, MA (US); Yang Chen, Lowell, MA (US); George Y. Gu, Austin, TX (US)

(73) Assignee: Evoqua Water Technologies LLC, Pittsburgh, PA (US)

(21) Appl. No.: 18/562,416

(22) PCT Filed: May 20, 2022
(86) PCT No.: PCT/US22/30258

§ 371 Date: Nov. 20, 2023

Related U.S. Application Data
(60) Provisional application No. 63/190,960, filed on May 20, 2021.
(60) Provisional application No. 63/192,824, filed on May 25, 2021.

(51) Int. Cl. C02F 1/467; C02F 1/00; C02F 1/461; C02F 1/78; C02F 101/34

(52) U.S. Cl. CPC C02F 1/4672; C02F 1/008; C02F 1/46104; C02F 1/78; C02F 2101/34; C02F 2201/46125; C02F 2201/46145; C02F 2201/782; C02F 2209/22; C02F 2209/23; C02F 2209/38; C02F 2209/40; C02F 2305/023

(57) ABSTRACT

Systems for treating water are disclosed. The system includes an ozonation subsystem including a source of ozone configured to dissolve ozone into water from a source of water to produce ozonated water. The system further includes an electrochemical cell co-located with the ozonation subsystem having an inlet connectable to a source of electrolyte and an outlet. The electrochemical cell is configured to produce hydrogen peroxide from electrolyte from the source of electrolyte. The system additionally includes a mixing zone configured to receive the ozonated water, to receive the hydrogen peroxide from the outlet of the electrochemical cell, and to mix the ozonated water and hydrogen peroxide to form peroxone. Systems and methods of treating water, such as by selectively removing one or more emergent compounds from contaminated water, using the system are also disclosed.

### CROSS-REFERENCE TO RELATED APPLICATIONS

This application claims priority under 35 U.S.C. § 119 (e) to U.S. Provisional Application Ser. No. 63/190,960, titled “Regulation of Onsite Peroxide Generation for Improved Peroxone Advanced Oxidative Process Control,” filed on May 20, 2021 and U.S. Provisional Application Ser. No. 63/192,824, titled “Selective Removal of 1,4-Dioxane From High TOC Wastewater,” filed May 25, 2021, the disclosures of which are each incorporated herein by reference in their entirety for all purposes.

### FIELD OF TECHNOLOGY

Aspects and embodiments disclosed herein relate to systems and methods for treating water contaminated with emergent compounds using on-site generation of hydrogen peroxide and on-site generation of ozone in the peroxone process.

### SUMMARY

In accordance with an aspect, there is provided a water treatment system. The water treatment system includes an ozonation subsystem including a source of ozone and configured to dissolve ozone into water from a source of water to produce ozonated water. The water treatment system further includes an electrochemical cell co-located with the ozonation subsystem, having an inlet connectable to a source of electrolyte and an outlet. The electrochemical cell is configured to produce hydrogen peroxide from electrolyte from the source of electrolyte. The water treatment system additionally includes a mixing zone configured to receive the ozonated water, to receive the hydrogen peroxide from the outlet of the electrochemical cell, and to mix the ozonated water and hydrogen peroxide for use in a peroxone process.

In some embodiments, the source of water and source of electrolyte are the same source, the same source being a source of water to be treated.

In further embodiments, the water treatment system may include a first conduit fluidically connecting the source of electrolyte to the inlet of the electrochemical cell and a second conduit fluidically connecting the outlet of the electrochemical cell to the ozonation subsystem.

In further embodiments, the water treatment system may include a first conduit configured to provide the ozonated water from the ozonation subsystem to water to be treated and a second conduit configured to provide the hydrogen peroxide from the electrochemical cell to the water to be treated. In certain embodiments, the water treatment system further may include a third conduit configured to flow the water to be treated from a source of the water to be treated. The third conduit may include a first inlet coupled to an outlet of the ozonation subsystem configured to receive the ozonated water and a second inlet coupled to the outlet of the electrochemical cell and configured to receive the hydrogen peroxide from the electrochemical cell. In some embodiments, the first inlet may be upstream of the second inlet, or the second inlet may be upstream of the first inlet. In further embodiments, the third conduit may include a product water outlet downstream of the first and second inlets. Alternatively, or in addition, both the first conduit and the second conduit may be fluidically coupled to a vessel in which water to be treated is mixed with the mixture of hydrogen peroxide and ozonated water in a batch mode treatment process.

In some embodiments, the outlet of the electrochemical cell is fluidically coupled to a point of introduction in a conduit fluidically coupling the source of electrolyte to the inlet of the electrochemical cell.

In some embodiments, the source of electrolyte may be a source of oxygenated water. In some embodiments, the source of electrolyte includes a source of oxygen and a mixer configured to receive water and oxygen from the source of oxygen and to dissolve the oxygen into the water. The mixer for the source of electrolyte may be configured to saturate the oxygenated water with oxygen. In some embodiments, the ozonation subsystem may be configured to dissolve sufficient ozone into the water such that the ozonated water is saturated with ozone, e.g., in accordance with Henry's Law.

In further embodiments, the water treatment system may include a sensor configured to measure a concentration of one or more contaminants in an aqueous solution passing through the system, the sensor positioned at one of an inlet or an outlet of the system. In further embodiments, the water treatment system may include a controller in communication with the sensor and configured to adjust one or more operating parameters of the system responsive to a measured concentration of the one or more contaminants. The one or more operating parameters of the system may include one or more of power applied to the electrochemical cell, power applied to the ozone generator, or a flow rate of the electrolyte parameters of the system may include an amount of oxygen dissolved in the electrolyte, e.g., from a source of oxygen or aeration.

In further embodiments, the water treatment system may include a sensor configured to measure a concentration of one or more of residual hydrogen peroxide, residual ozone, or a residual contaminant in water treated by the system. The sensor may be operatively coupled to and in communication with a controller configured to adjust one or more operating parameters of the system responsive to a measured concentration of the one or more of residual hydrogen peroxide or residual ozone. In some embodiments, the one or more operating parameters of the system may include one or more of power applied to the electrochemical cell, power applied to the ozone generator, or a flow rate of the electrolyte through the electrochemical cell. In certain embodiments, the one or more operating parameters of the system may include one or both of an amount of oxygen dissolved in the electrolyte or an amount of ozone dissolved in the ozonated water.

In further embodiments, the water treatment system may include a storage tank fluidically coupled to the outlet of the electrochemical cell. The storage tank may be operatively coupled to a controller configured to adjust one or both of a flow rate of hydrogen peroxide from the storage tank or a flow rate of gaseous ozone from the source of ozone based on one or more measured characteristics of the electrolyte or one or more characteristics of the ozonated water.

In further embodiments, the water treatment system may include a controller configured to control a ratio of hydrogen peroxide to ozone received in the mixing zone to between about 10:1 and about 50:1, e.g., about 30:1.

In accordance with an aspect, there is provided a method of treating water. The method includes producing ozonated water with an ozonation subsystem including a source of ozone and configured to dissolve ozone into water from a source of water. The method may include producing hydrogen peroxide in an electrochemical cell co-located with the source of ozone and configured to produce hydrogen peroxide from electrolyte from a source of electrolyte. The electrochemical cell may have an inlet connectable to the source of electrolyte and an outlet. The method further may include mixing the ozonated water and hydrogen peroxide in a mixing zone. The method additionally may include exposing water to be treated to the mixture of ozonated water and hydrogen peroxide in a peroxone process.

In some embodiments, both the water provided to the ozonation subsystem and the electrolyte may be provided from a source of the water to be treated.

In further embodiments, the method of treating water may include fluidically connecting the source of electrolyte to the inlet of the electrochemical cell and fluidically connecting the outlet of the electrochemical cell to the ozonation subsystem.

In further embodiments, the method of treating water may include providing the ozonated water from the ozonation subsystem to water to be treated through a first conduit and providing the hydrogen peroxide from the electrochemical cell to the water to be treated through a second conduit. The method may further include flowing the water to be treated from a source of the water to be treated through a third conduit including a first inlet coupled to an outlet of the ozonation subsystem and configured to receive the ozonated water and a second inlet coupled to the outlet of the electrochemical cell and configured to receive the hydrogen peroxide from the electrochemical cell. In some embodiments, the ozonated water may be introduced into the water to be treated upstream of a point of introduction of the hydrogen peroxide into the water to be treated. Alternatively, the ozonated water may be introduced into the water to be treated downstream of a point of introduction of the hydrogen peroxide into the water to be treated.

In some embodiments, the water to be treated may be treated by the peroxone process in a batch mode treatment process.

In further embodiments, the method of treating water may include fluidically coupling the outlet of the electrochemical cell to a point of introduction in a conduit fluidically coupling the source of electrolyte to the inlet of the electrochemical cell. In further embodiments, the method of treating water may include dissolving oxygen into water to form oxygenated water as the electrolyte. The dissolving of the oxygen into water to form the oxygenated water may include saturating the oxygenated water with oxygen. In certain embodiments, the method of treating water may include dissolving sufficient ozone into the water such that the ozonated water is saturated with ozone.

In further embodiments, the method of treating water may include measuring a concentration of one or more contaminants in an aqueous solution passing through the system at one of an inlet or an outlet of the system. In further embodiments, the method of treating water may include adjusting one or more operating parameters of the system responsive to a measured concentration of the one or more contaminants. In some embodiments, the one or more parameters to be adjusted may include one or more of power applied to the electrochemical cell, power applied to the ozone generator, or a flow rate of the electrolyte parameters of the system may include an amount of oxygen dissolved in the electrolyte. In further embodiments, the one or more operating parameters of the system includes an amount of oxygen dissolved in the electrolyte.

In further embodiments, the method of treating water may include adjusting one or more operating parameters of the system responsive to a measured concentration of one or more of residual hydrogen peroxide or residual ozone in treated water exiting the system. The one or more operating parameters of the system to be adjusted responsive to the measured concentration of the one or more of residual hydrogen peroxide, residual ozone, or residual of one or more contaminants may include one or more of power applied to the electrochemical cell, power applied to the ozone generator, or a flow rate of the electrolyte through the electrochemical cell. In certain embodiments, the one or more operating parameters of the system may include an amount of oxygen dissolved in the electrolyte or an amount of ozone dissolved in the ozonated water.

In further embodiments, the method of treating water may include delivering the hydrogen peroxide to a storage tank fluidically coupled to the outlet of the electrochemical cell. In further embodiments, the method of treating water may include adjusting one of a flow rate of hydrogen peroxide from the storage tank or a flow rate of gaseous ozone from the source of ozone based on one or more measured characteristics of the electrolyte or one or more characteristics of the ozonated water.

In accordance with an aspect, there is provided a method of selectively removing one or more emergent compounds from contaminated water. The method includes providing contaminated water comprising a first concentration of one or more emergent compounds. The method includes electrochemically generating an aqueous solution of hydrogen peroxide and generating an aqueous solution of ozone. The method further includes mixing the aqueous solution of hydrogen peroxide and the aqueous solution of ozone with the contaminated water to oxidize at least a portion of the one or more emergent compounds in a peroxone process to produce a treated water. The method further includes determining a second concentration of the one or more emergent compounds in the treated water. The method may additionally include adjusting one or more of a reaction time of the peroxone process, a concentration of hydrogen peroxide in the aqueous solution of hydrogen peroxide, or a concentration of ozone in the aqueous solution of ozone introduced into the contaminated water based on the second concentration of the one or more emergent compounds.

In some embodiments, selectively removing the one or more emergent compounds includes removing one or more heterocyclic organic compounds. For example, the one or more heterocyclic organic compounds may include one or more heterocyclic ethers, such as 1,4-dioxane. Thus, in certain embodiments, selectively removing the heterocyclic organic compounds may include selectively removing 1,4-dioxane. The contaminated water further may include one or more additional organic components having an elevated total organic carbon (TOC) background. The one or more additional organic components may be present in the contaminated water at a concentration higher than 100 ppm.

In certain embodiments, the step of adjusting includes adjusting to control the second concentration of the one or more emergent compounds to be below a predetermined concentration.

In further embodiments, electrochemically generating the hydrogen peroxide includes generating hydrogen peroxide in an electrochemical cell from an electrolyte. The electrolyte may be generated by dissolving oxygen in an aqueous solution. In some embodiments, the electrolyte may be generated by dissolving oxygen in the contaminated water or in a treated water from a separate source. In certain embodiments, the ozone used to produce the ozonated aqueous solution may be generated using a source of oxygen and one of a source of voltage or a source of ultraviolet light.

In further embodiments, the method may include generating the ozonated aqueous solution by dissolving ozone in an aqueous solution. For example, the ozonated aqueous solution may be generated by dissolving ozone in the contaminated water. In further embodiments, the method may include generating the ozonated aqueous solution in an ozonation subsystem co-located with the electrochemical cell.

In certain embodiments, adjusting the concentration of the aqueous solution of hydrogen peroxide may include one or both of adjusting a concentration of dissolved oxygen in the electrolyte or adjusting power supplied to the electrochemical cell.

In some embodiments, the method of selectively removing the one or more emergent compounds from the contaminated water may be performed as a continuous flow process. In other embodiments, the method of selectively removing the one or more emergent compounds from the contaminated water may be performed as a batch process.

In some embodiments, the predetermined time is two hours or less.

In accordance with an aspect, there is provided a system for selectively removing one or more emergent compounds from contaminated water. The system includes an ozonation subsystem including a source of ozone and configured to dissolve ozone into water from a source of water to produce ozonated water. The system further includes an electrochemical cell co-located with the ozonation subsystem. The electrochemical cell includes an inlet connectable to a source of electrolyte having an outlet, with the electrochemical cell constructed and arranged to produce hydrogen peroxide from electrolyte from the source of electrolyte. The system further includes a first mixing zone configured to receive the ozonated water and the hydrogen peroxide from the outlet of the electrochemical cell and to mix the ozonated water and hydrogen peroxide. The system additionally includes a second mixing zone configured to receive and mix the mixture of hydrogen peroxide and ozone and at least the one or more emergent compounds in the contaminated water by a peroxone process to form a treated water.

In some embodiments, the source of water is a source of the contaminated water. The contaminated water may be used as the source of electrolyte for the electrochemical cell.

In further embodiments, the system may include a controller configured to adjust one or both of the reaction time of the peroxone process or a concentration of one or both of the hydrogen peroxide or ozone in the ozonated water introduced into the contaminated water based on a measured concentration of the one or more emergent compounds in the treated water. In further embodiments, the controller may be configured to adjust the concentration of the hydrogen peroxide by one or both of adjusting a concentration of dissolved oxygen in the electrolyte or adjusting power applied to the electrochemical cell.

In some embodiments, the system may include a controller configured to introduce the ozonated water and hydrogen peroxide into the mixing zone at a ratio of a concentration of the hydrogen peroxide to a concentration of the ozone of from about 10:1 to about 50:1.

In some embodiments, the system for selectively removing one or more emergent compounds from contaminated water may be configured to treat the contaminated water in a continuous flow process. In the continuous flow process, the controller may be further configured to adjust a rate of introduction of the hydrogen peroxide and ozone into the contaminated water during the peroxone process.

In some embodiments, the first mixing zone includes a vessel configured to hold a volume of the hydrogen peroxide and a volume of the ozonated water and dose the mixture of the hydrogen peroxide and ozonated water into the second mixing zone at a rate or period controlled by a controller of the system. In some embodiments, the second mixing zone includes a vessel and the system is configured to form the treated water by reacting the mixture of the hydrogen peroxide and ozonated water and the contaminated water in a batch process in the vessel. In some embodiments, the first mixing zone and the second mixing zone are different zones with a same vessel.

### BRIEF DESCRIPTION OF THE DRAWINGS

The accompanying drawings are not drawn to scale. In the drawings, each identical or nearly identical component that is illustrated in the various figures is represented by a like numeral. For purposes of clarity, not every component may be labeled in every drawing. In the drawings:

FIG. 1 illustrates a schematic of an electrochemical cell used to generate hydrogen peroxide:

FIG. 2 illustrates a water treatment system, according to an embodiment:

FIG. 3 illustrates a water treatment system, according to another embodiment:

FIG. 3 illustrates a water treatment system, according to another embodiment:

FIG. 5 illustrates a water treatment system, according to another embodiment

FIG. 6 illustrates a water treatment system, according to another embodiment:

FIG. 7 illustrates a water treatment system, according to another embodiment:

FIG. 8 illustrates a water treatment system, according to another embodiment:

FIG. 9 illustrates a water treatment system, according to another embodiment:

FIG. 10 is a flowchart of a method of treating water, according to an embodiment:

FIG. 11 illustrates the current-voltage characteristic curves and rate of hydrogen peroxide production using an electrochemical cell according to an embodiment:

FIG. 12 illustrates the concentration profile over time of the removal of 1,4-dioxane and background TOC during treatment with an electrochemical advanced oxidation process:

FIG. 13 illustrates the concentration profile over time of the removal of 1,4-dioxane and background TOC during treatment with a hybrid treatment with both a peroxone process and an electrochemical advanced oxidation process: and

FIG. 14 illustrates the concentration profile over time of the removal of 1,4-dioxane and background TOC during treatment with a peroxone process.

### DETAILED DESCRIPTION

Pressure to clean up contaminated sites has continued under government regulation which requires removal, reduction, destruction, or stabilization of environmentally hazardous chemical compounds. However, certain groundwater contaminants are difficult to treat in a cost-effective manner. These contaminants have gained a reputation as being “recalcitrant” primarily as a result of fundamental physicochemical properties that make treatment difficult.

Advanced oxidation processes (AOP) may be used for the destruction or inactivation of undesirable organic compounds in an aqueous solution. In general, AOPs are chemical treatment procedures designed to remove certain classes of chemicals present in water by oxidation through reactions with free radicals. AOPs for water treatment may utilize highly reactive radical species, for example, hydroxyl radicals (·OH), for oxidation and subsequent destruction of toxic, non-biodegradable, or less-biodegradable hazardous water contaminants, for example, industrial contaminants.

AOP treatments generally utilize activation of an oxidizing salt for the destruction or elimination of organic species. Any salt that can initiate as a precursor to produce an oxidizing free radical may be utilized. Exemplary methods for activation of the oxidant include ultraviolet (UV) irradiation (UV-AOP), ultrasonic cavitation, application of an electrochemical potential, and other methods. Exemplary oxidants that may be activated include oxygen gas (O₂), ozone (O₃), hydrogen peroxide (H₂O₂), and persulfate (SO₅²⁻ or S₂O₈²⁻).

Due to the high oxidation potential and low selectivity of the hydroxyl radicals, i.e., non-selective reaction with nearly all known organic compounds, AOPs can be used to oxidize many different types of compounds found in the environment. Many of these compounds include what are termed emergent compounds that have become a cause for concern as regulatory authorities and agencies assess their impact on the environment. As used herein, “emergent compounds” refers to a diverse group of compounds found in groundwater and soils that have been found to be difficult to remove using traditional wastewater treatment methodologies. “Emergent compounds” include, but are not limited to, pesticides, industrial solvents, e.g., heterocyclic hydrocarbons, e.g., heterocyclic ethers, e.g., 1,4-dioxane, aromatic and polyaromatic solvents, per-and polyfluoroalkyl substances (PFAS), pharmaceuticals, hormones, biologics, personal care products, or radiological contrast media from contaminated water. “Emergent compounds” also include those described in any of the United States Environmental Protection Agency (EPA) publication numbers EPA 505-F-17-007, EPA 505-F-17-011, EPA 505-F-21-001, EPA 505-F-21-002, EPA 505-F-21-003, EPA 505-F-17-002, EPA 505-F-17-005, EPA 505-F-17-003, EPA 505-F-17-016, EPA 505-F-17-015, and EPA 505-F-17-004. Hydroxyl radical treatments have been used in the water and wastewater treatment industries to remediate difficult to treat compounds, such as taste and odor compounds, and can be effective in oxidizing halogenated compounds.

1,4-Dioxane, a heterocyclic ether, is one example of an emergent compounds that can be difficult to remove from contaminated water. 1,4-Dioxane is a clear liquid that miscible with and soluble in water. 1,4-Dioxane is used primarily as a solvent in the manufacture of other chemicals and as a laboratory reagent, in addition to other varied uses that take advantage of its solvent and miscibility properties. 1,4-Dioxane is an industrial synthetic chemical which has been used as a stabilizer for chlorinated solvents (including 1,1,1-trichloroethane (methyl chloroform)). 1,4-Dioxane has also been used in the production of cellulose acetate membranes, resins, printing inks, paints, adhesives, cosmetics, deodorants, fumigants, detergents, cleaning products, and aircraft deicing fluids. A majority of the locations where dioxane is found to contaminate drinking groundwater supplies are linked to industrial areas and hazardous waste landfills. Occurrence of 1,4-dioxane in groundwater has been reported throughout the U.S. as 1,4-dioxane is resistant to biological degradation and continues to be present in the environment. However, manufacturers now reduce 1,4-dioxane from these products to low levels before these products are made into consumer goods.

The challenge in treating 1,4-dioxane contaminated water is attributed to the miscibility of 1,4-dioxane in water, which makes it difficult to remove using conventional treatment methods such as granular activated carbon (GAC) adsorption and air stripping. The U.S. EPA identifies the most serious hazardous waste sites in the nation. These sites are then placed on the National Priorities List (NPL) and are targeted for long-term federal clean-up activities. 1,4-Dioxane has been found in a majority of the 1,689 current or former NPL sites. Although the total number of NPL sites evaluated for this substance is not known, the possibility exists that the number of sites at which 1,4-dioxane is found may increase in the future as more sites are evaluated. Since 1,4-dioxane is considered a hazardous material that contaminates ground water, there is a need for systems and processes that will selectively remove 1,4-dioxane from groundwater in view of a high background concentration of TOC. Removal of 1,4-dioxane been contemplated by the use of a combination of hydrogen peroxide and ultraviolet light (UV) or the combination of ozone with UV light to break down 1,4-dioxane. 1,4-Dioxane can be broken down by advanced oxidation processes (AOPs) using a combination of hydrogen peroxide (H₂O₂), ozone (O₃), and ultraviolet light (UV) such as combinations of H₂O₂/UV, O₃/UV, H₂O₂/O₃, i.e., the peroxone process, and H₂O₂/O₃/UV. These AOPs involve the production and use of oxidizing hydroxyl free radicals to break down organic compounds, e.g., 1,4-dioxane.

1,4-Dioxane is a known carcinogenic substance if ingested or otherwise absorbed into the human body. For example, both the U.S. EPA and the Commonwealth of Massachusetts regulate the permitted level of 1,4-dioxane in the environment, i.e., in potable water, setting a maximum concentration of 300 ppt for drinking water. In addition to drinking water contamination, 1,4-dioxane is also detrimental to plants if introduced via contaminated irrigation water. When 1,4-dioxane is discharged as wastewater from industry, the discharge usually contains an elevated level of other organic contaminants. Some of these organic contaminants are biodegradable or not regulated by government agencies. Background organic contaminants can be removed using anodic oxidation, electrochemical advanced oxidation process (AOP), UV AOP, or the Fenton method. There are a number of disadvantages associated with UV AOPs. Color, turbidity, and fouling constituents such as iron and manganese should be removed prior to the treatment processes to a level sufficient to facilitate UV transmission and prevent fouling onto UV light sources. Constituents such as carbonate, bicarbonate, reduced metal ions, total organic carbon (TOC), and nitrite (NO₂⁻) may scavenge hydroxyl free radicals and inhibit target organic destruction. The operational costs associated with UV light production can be very high. While these methods will also remove 1,4-dioxane along with other organic contaminants present in the wastewater, these processes are not selective and thus reduce the efficiency of 1,4-dioxane removal. Aspects and embodiments disclosed herein include systems and methods that can efficiently and with high selectivity remove 1,4-dioxane, among other emergent compounds, from a mixture with other organic contaminants.

AOP in general is a versatile method to produce hydroxyl radicals, permitting compliance with specific treatment requirement of various end uses and regulatory agencies. Some pathways for producing hydroxyl radicals include:

OH⁻+O₃→O₂+OH₂⁻ [symbol] H₂O₂ (1)

OH₂⁻+O₃→HO₂^{·}+O₃^{·-} (2)

HO₂^{·} [symbol] H⁺+O₂^{·-} (3)

O₂^{·-}+O₃→O₂+O₃^{·-} (4)

O₃^{·-}+H⁺→HO₃^{·} (5)

HO₃^{·}→·OH+O₂ (6)

·OH+O₃→HO₂^{·}—O₂ (7)

In addition to the varied mechanisms for producing hydroxyl radicals using AOPs, the formation of hydroxyl radicals is also dependent on the pH of the surrounding medium as the ozone decomposition mechanism has as the active species the conjugate base HO₂ whose concentration is pH dependent. The increase of pH and the addition of H₂O₂ to an aqueous solution including ozone may, under certain conditions, result into higher rates of hydroxyl radical production and the attainment of higher steady-state concentrations of hydroxyl radicals in the radical chain decomposition process.

Hydrogen peroxide is a strong oxidizing agent capable on its own of removing disease-causing organisms and persistent organic pollutants from aqueous solutions. Importantly, its intrinsic decomposition route results in the production of harmless byproducts, i.e., water and oxygen. Despite these favorable properties, low-cost decentralized H₂O₂ production is a challenge as industrial production using typical anthraquinone oxidation is not conducive to treatment-scale operations at the municipal level or other similar water treatment environments. In addition, the instability of H₂O₂ poses a safety issue for transportation and both short-and long-term storage, which further limits the use of standalone H₂O₂ for large-scale water treatment. Hydrogen peroxide can be made electrochemically in an electrochemical cell by the two-electron reduction of oxygen (O₂) present in a source of water. Disclosed herein are systems and methods for the on-site electrochemical production of hydrogen peroxide and use of the formed hydrogen peroxide mixed with on-site produced ozone for use in a peroxone process to treat water.

This disclosure describes various embodiments of electrochemical cells and electrochemical devices; however, this disclosure is not limited to electrochemical cells or devices and the aspects and embodiments disclosed herein are applicable to electrolytic and electrochemical cells used for any one of multiple purposes.

In certain non-limiting embodiments, this disclosure describes a water treatment system. Systems described herein include an ozonation subsystem including a source of ozone and configured to dissolve ozone into water from a source of water to produce ozonated water and an electrochemical cell co-located with the ozonation subsystem having an inlet connectable to a source of electrolyte and an outlet. The electrochemical cell may be configured to produce hydrogen peroxide from electrolyte from the source of electrolyte. The ozone generated in the ozonation subsystem and the hydrogen peroxide generated by the electrochemical cell may be delivered to a first mixing zone that mixes the ozone and hydrogen peroxide. This mixture can then be mixed with contaminated water to form a treated water in a second mixing zone.

Ozone can, in general, be produced from the electrolysis or photolysis of oxygen gas which can be dissolved into water. Ultraviolet light in the vacuum UV portion of the electromagnetic spectrum (˜185 nm) can separate diatomic oxygen into singlet oxygen atoms, which can consequently combine with diatomic oxygen to produce ozone:

O₂+hv→2O (8)

2O+2O₂→O₃ (9)

Similar reactions occur when oxygen is dissociated in an electrical field to produce ozone:

O₂+e−→2O+e− (10)

2O+2O₂→Oₑ (11)

In some embodiments, ozone generation systems may include a source of oxygen to increase the oxygen content available for producing ozone. The source of oxygen may include a compressed gas source, an electrochemical cell, e.g., O₂ from water splitting, an air stripper, a gas concentrator, or other similar source of oxygen.

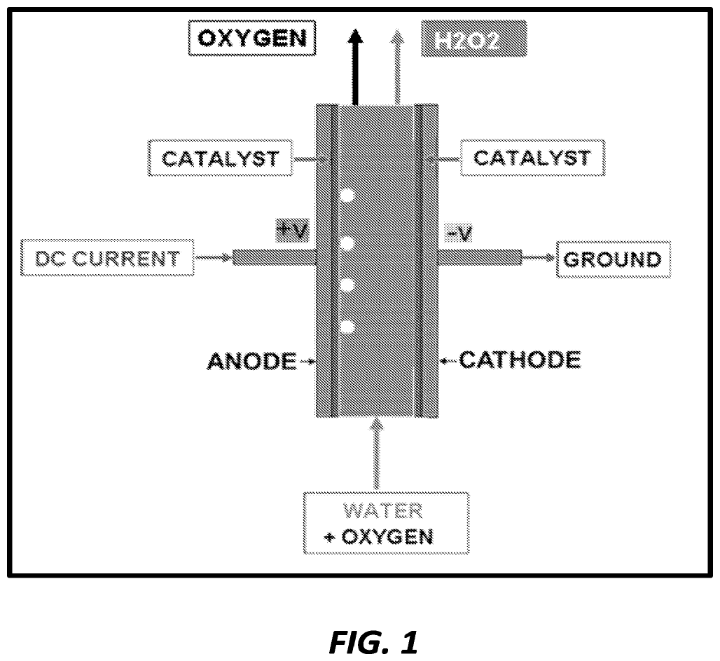

Electrochemical generation of hydrogen peroxide can occur via the two-electron reduction of oxygen gas present in a source of water. An embodiment of the electrochemical cell-based hydrogen peroxide generation process is illustrated in FIG. 1. In the electrochemical cell, water and dissolved oxygen, either the naturally occurring oxygen present in water or additional dissolved oxygen added from a source of oxygen, are directed past the anode and cathode of the electrochemical cell. The anode and the cathode are made from a catalytic material, such as a transition metal or oxide thereof, or are coated in the same. The electrochemical cell is driven at a voltage and current density sufficient to consume at least some of the oxygen in the water and to form hydrogen peroxide and additional oxygen as a byproduct at the cathode. The reactions for forming hydrogen peroxide and oxygen are:

| | | |
|---|---|---|
| Anode: | 2H₂O → O₂ + 4H⁺ + 4e⁻ | E^{o}ₒₓ = −1.23 V (Oxygen Generation) |
| Cathode: | O₂ + 2H⁺ + 2e⁻ → H₂O₂ | E^{o}_{red} = +0.682 V (Oxygen Consumption) |
| | | E^{o}_{cell} = −0.548 V |

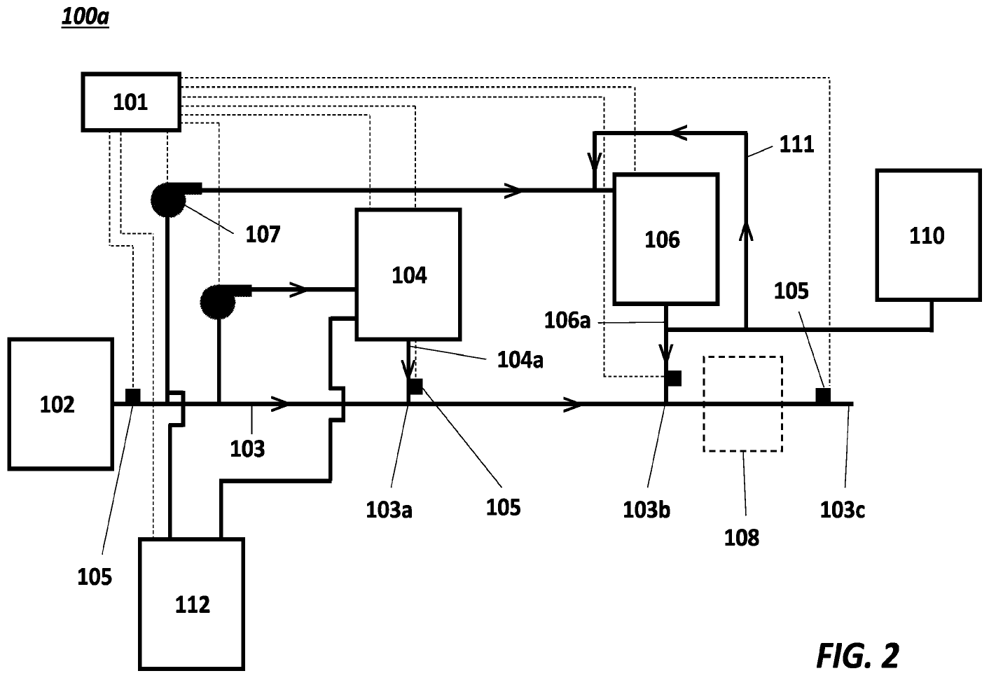

Embodiments of a water treatment system are illustrated in FIGS. 2-6. In FIGS. 2, 3, 5, and 6, system 100a, 100b, 100d, and 100e includes a source of water 102 connectable to an inlet of an electrochemical cell 106 and an ozonation subsystem 104 including a source of ozone. An inlet of the electrochemical cell 106 is connectable to the source of water 102. which acts as a source of electrolyte for the electrochemical cell 106. In this configuration, the system 100 includes a source of oxygen 112 constructed and arranged to provide and mix oxygen into the water from the source of water 102 to produce oxygenated water to facilitate the production of hydrogen peroxide in the electrochemical cell 106 from the oxygenated water. The source of oxygen 112 may provide sufficient oxygen into the water to saturate the oxygenated water with oxygen. The source of oxygen 112 provides oxygen to the ozonation subsystem 104 to produce ozone to be dissolved into and optionally saturate the water from the source of water 102 with ozone, e.g., in accordance with Henry's Law. The electrochemical cell 106 and ozonation subsystem 104 may be co-located. The co-location of the ozonation subsystem 104 and electrochemical cell 106 can be serially as shown in FIG. 2 or can be in parallel. Water from the source of water 102 can be distributed to the ozonation subsystem 104, the electrochemical cell 106, or other regions of the system 100 using flow control devices such as pumps 107 and valves. Mixing zone 108 in the dashed box is configured to receive the ozonated water from the ozonation subsystem 104, receive the hydrogen peroxide from the outlet of the electrochemical cell 106, and to mix the ozonated water and hydrogen peroxide.

In some embodiments, such as illustrated in FIG. 2, the outlet of the electrochemical cell 106 is fluidically coupled to a point of introduction in a conduit fluidically coupling the source of electrolyte 102 to the inlet of the electrochemical cell 106. A recycle line 111 can return a hydrogen peroxide solution output from the electrochemical cell 106 back to the inlet of the electrochemical cell 106 to increase the hydrogen peroxide concentration being delivered to the water to be treated if a single pass through the electrochemical cell 106 produces an insufficient amount of hydrogen peroxide. In addition, the recycle line 111 may improve operating efficiency of the electrochemical cell 106 by reducing scaling, fouling, or blinding of the electrodes within the electrochemical cell 106.

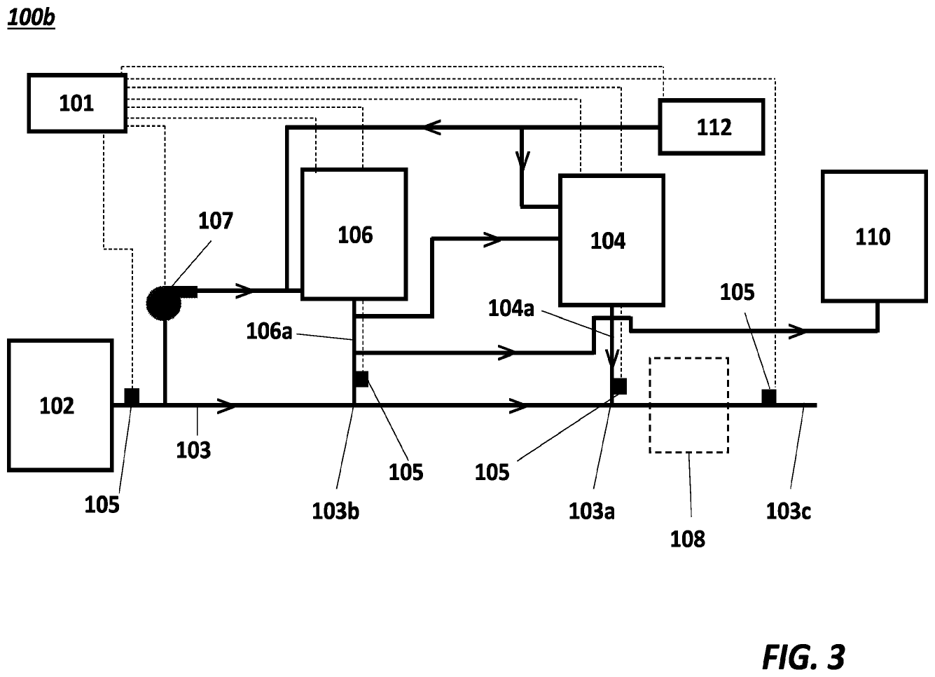

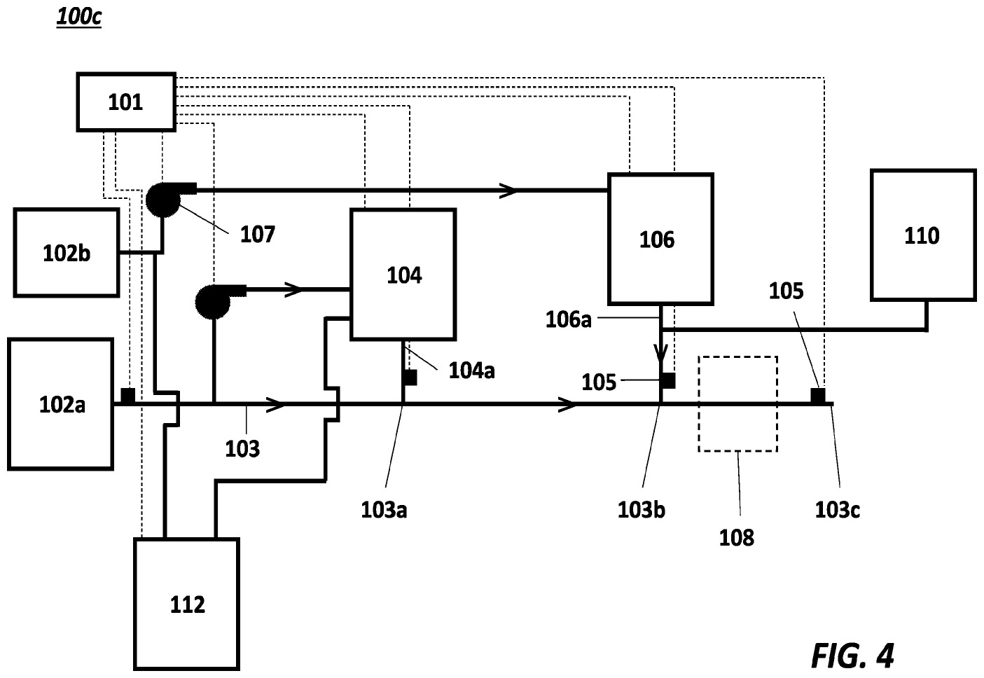

As illustrated in FIGS. 2-6, a first conduit 104a is configured to provide the ozonated water from the ozonation subsystem 104 to water to be treated and second conduit 106a is configured to provide the hydrogen peroxide from the electrochemical cell 106 to the water to be treated. Alternatively, in some embodiments, a conduit can fluidically connect the source of electrolyte to an inlet of the electrochemical cell and/or a conduit can fluidically connect the outlet of the electrochemical cell to the ozonation subsystem. Third conduit 103 is configured to flow the water to be treated from a source of the water 102 to be treated. Third conduit 103 includes a first inlet 103a coupled to an outlet of the ozonation subsystem 104 configured to receive the ozonated water and a second inlet 103b coupled to the outlet of the electrochemical cell 106 and configured to receive the hydrogen peroxide from the electrochemical cell 106. Third conduit 103 additionally includes product water outlet 103c to discharge treated water. As illustrated in FIGS. 2, 4, 5, and 6, first inlet 103a is upstream of second inlet 103b as the ozonation subsystem 104 is positioned upstream of the electrochemical cell 106. In an alternative arrangement, such as illustrated in FIG. 3, the electrochemical cell 106 can be positioned upstream of the ozonation subsystem 104, and thus second inlet 103b can be upstream of first inlet 103a. This disclosure is in no way limited by the positioning of the ozonation subsystem 104 and electrochemical cell 106.

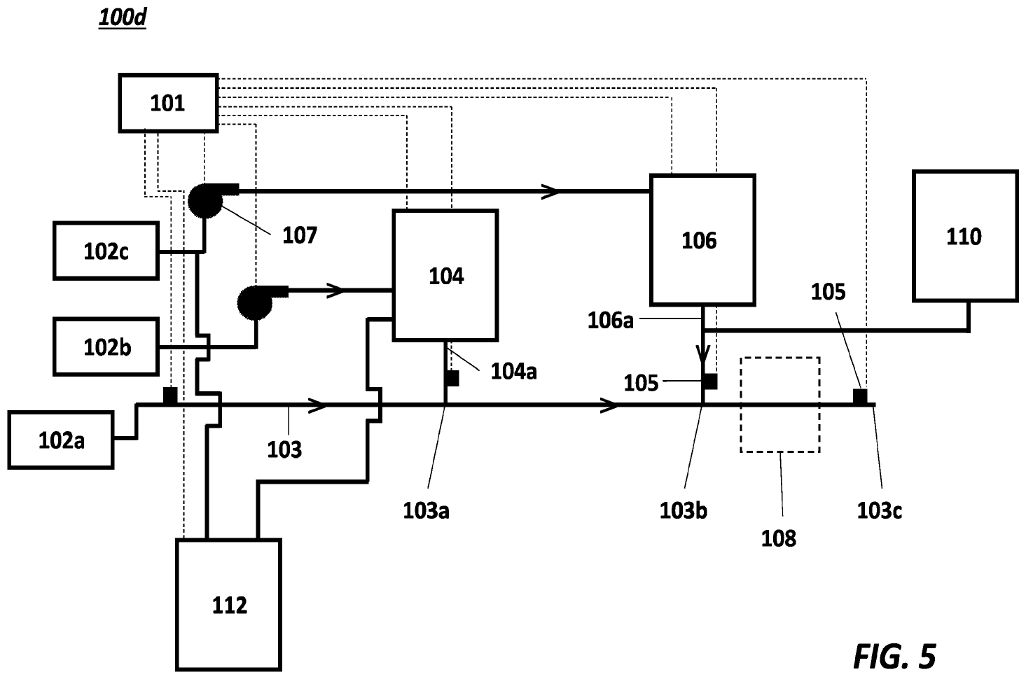

As illustrated in FIGS. 2, 3, and 6, the source of water for the ozonation subsystem 104 and the electrochemical cell 106, i.e., the source of electrolyte, may be the source of contaminant water 102 or water to be treated. In an alternate arrangement, such as that illustrated in FIG. 4, the source of water for the ozonation subsystem 104 and the source of water, i.e., electrolyte, for the electrochemical cell 106 may be separate sources. As illustrated in FIG. 4, the source of contaminated water 102a is fluidly coupled to the ozonation subsystem 104 and a source of water 102b, i.e., electrolyte, is fluidly coupled to the electrochemical cell 106. In a further alternate arrangement, such as that illustrated in FIG. 5, the source of water to be treated 102a, the source of water 102b for the ozonation subsystem 104 and the source of water 102c, i.e., electrolyte, for the electrochemical cell 106 may all be separate sources of water. In any embodiment where the source of water for the ozonation subsystem 104 and electrochemical cell 106 are separate, the water may be a water treated with one or more treatment steps to improve its overall quality, such as one or more of carbon filtration, nanofiltration, reverse osmosis, ion exchange treatments, nanobead treatment, electrodeionization, or capacitive deionization. This disclosure is not limited by the source of electrolyte and any treatment processes used in its production.

With continued reference to FIGS. 2-6, an outlet of the ozonation subsystem 104 and an outlet of the electrochemical cell 106 are connectable to a first mixing zone 108 that is constructed and arranged to mix the ozonated water from the ozonation subsystem 104 and the hydrogen peroxide generated in the electrochemical cell 106. The connection between the outlet of the ozonation subsystem 104 and the outlet of the electrochemical cell 106 may be through the third conduit 103 as illustrated. Alternatively, the connection between the outlet of the ozonation subsystem 104 and the outlet of the electrochemical cell 106 and the mixing zone 108 may be separate connections, i.e., not through a shared fluid connection. The system 100 can include storage tank 110 fluidically coupled to the outlet of the electrochemical cell 106. Storage tank 110 can be used to hold formed hydrogen peroxide that is ready to use in the system 100, e.g., in a batch treatment process, or another process upstream or downstream of the system 100.

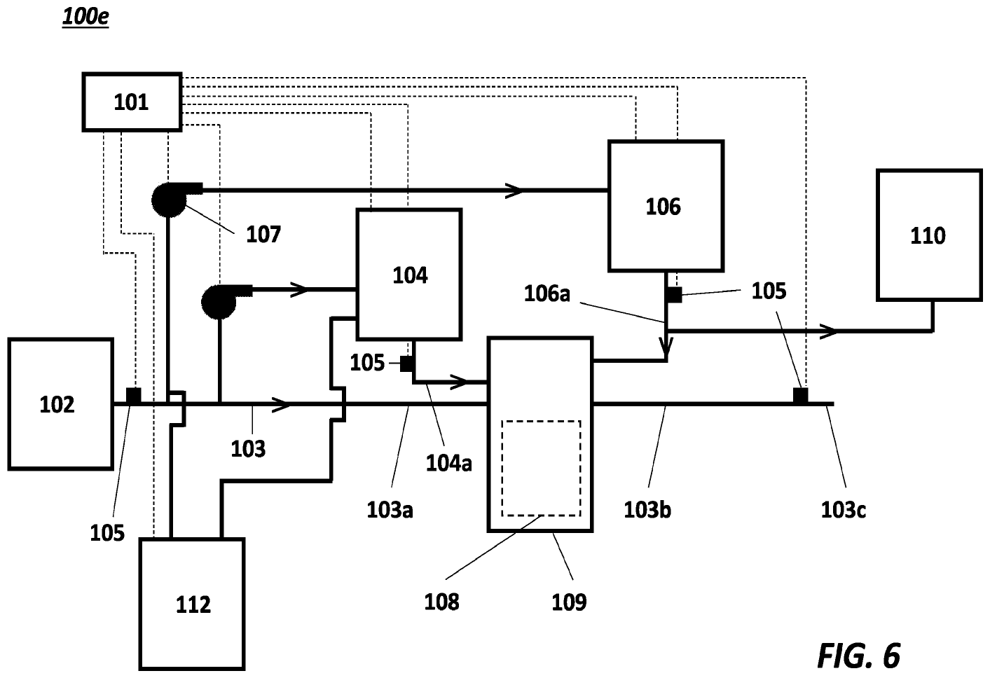

With reference to FIG. 6, system 100e includes vessel 109 fluidly coupled to the outlet of the ozonation subsystem 104 and the electrochemical cell 106. In this configuration, the mixing zone 108 for mixing ozonated water and hydrogen peroxide is disposed within the vessel 109, which acts to store the mixture. The vessel 109 includes an inlet and an outlet to permit water from the source of water 102 to be added to and subsequently discharged from the vessel 109. Within the vessel 109, the mixing zone 108 for forming the mixture of hydrogen peroxide and ozonated water may be separate from the water to be treated within the vessel 109 and added to the water in a batch process, i.e., treating discrete volume of water with a volume of the mixture of hydrogen peroxide and ozonated water. In this configuration, the mixing zone 108 and vessel 109 may have independently controllable structural elements, operable by the controller 101, to permit the mixing of ozonated water and hydrogen peroxide and to dose this mixture into the water, respectively. The mixing zone 108 and water in the vessel 109 may be separated by any suitable partitioning scheme, such as by a solid divider with a fluidic connection, a permeable barrier, vertically oriented chambers, i.e., a spillway, or any other configuration constructed and arranged to separate the mixing zone 108 and water in the vessel 109. Alternatively, the addition of a volume of mixed ozonated water and hydrogen peroxide from the mixing zone 108 into water contained within the vessel 109 can occur substantially simultaneously without a delineated separation.

In some embodiments, the system 100a, 100b, 100c, 100d, and 100e may include one or more sensors 105 positioned upstream or downstream of one or more of the ozonation subsystem 104, electrochemical cell 106, or mixing zone 108. The one or more sensors 105 may include, for example, flow meters, water level sensors, conductivity meters, resistivity meters, chemical concentration meters, turbidity monitors, chemical species specific concentration sensors, temperature sensors, pH sensors, oxidation-reduction potential (ORP) sensors, pressure sensors, or any other sensor, probe, or scientific instrument useful for providing an indication of a desired characteristic or parameter of the contaminated water, ozonated water, hydrogen peroxide, or treated water entering or effluent exiting any one or more of the ozonation subsystem 104, electrochemical cell 106, or mixing zone 108. The one or more sensors 105 may be configured to measure a concentration of one or more of residual hydrogen peroxide or residual ozone in water treated by the system. The measured concentrations of one or more of the residual hydrogen peroxide or residual ozone in water treated by the system 100 can be used by a controller 101 to determine how to adjust one or more operating parameters of the system 100 to improve system performance. This disclosure is in no way limited by the total number, type, and positioning of the one or more sensors 105 in the system 100a, 100b, 100c, 100d, or 100e.

As illustrated in FIGS. 2-6, one of the one or more sensors 105 is positioned near the treated water outlet 103c of the third conduit 103 and is configured to measure a concentration of one or more contaminants in the aqueous solution, i.e., water being treated, passing through the system 100. The one or more sensors 105 may be configured to collect data regarding the measured concentration of one or more contaminants or a parameter indicative of the presence of one or more contaminants continuously or according to a predetermined schedule. For example, the one or more sensors may be configured to collect data at intervals of minutes, such as every 1 minute, 2 minutes, 3 minutes, 4 minutes, 5 minutes, 6 minutes, 7 minutes, 8 minutes, 9) minutes, 10 minutes, 20 minutes, 30 minutes, 40 minutes, 50 minutes, or 60 minutes. In some implementations, the one or more sensors 105 may be configured to collect data at intervals of hours, such as every 1 hour, 2 hours, 3 hours, 4 hours, 5 hours, 6 hours, 7 hours, 8 hours, 9 hours, 10 hours, 12 hours, 18 hours, or 24 hours. The data corresponding to the measured parameters that pertain to the concentration or presence of the one or more contaminants may use the controller 101 to determine how to adjust one or more operational parameters of the system to improve system performance.

With continued reference to FIGS. 2-6, the system 100 includes a controller 101 configured to adjust one or more operating parameters of the system 100 that control the production of treated water. In general, the controller 101 can adjust one or more of the production of ozone and ozonated water from the ozonation subsystem 104, the production of hydrogen peroxide from the electrochemical cell 106, the production of the mixture of ozonated water and hydrogen peroxide in the mixing zone 108, and the production of treated water. The operational parameters adjusted by the controller 101 may be related to measurements collected from the one or more sensors 105 positioned at locations within the system 100 as described herein. For example, the controller 101, based on the measured concentrations of one or more contaminants from the one or more sensors 105 can adjust one or more of power applied to the electrochemical cell 106, power applied to the ozone generator in the ozonation subsystem 104, or a flow rate of the electrolyte through the electrochemical cell 106. Each of these adjustments can either increase or decrease the production of hydrogen peroxide or ozone, and thus adjust the concentration of hydroxyl radicals formed in the mixing zone 108 as part of the peroxone process. Adjustment of the electrochemical cell 106 responsive to the measured concentration of one or more contaminants from the one or more sensors can include adjusting an amount of oxygen dissolved in the electrolyte introduced into the electrochemical cell 106, i.e., adjusting the flow of oxygen or the mixing from the source of oxygen 112 in the water to be used as the electrolyte.

The one or more sensors 105, as disclosed herein, can measure the residual concentrations of hydrogen peroxide or ozone in water treated by the system 100. One or more of these measurements may be used by the controller 101 to adjust one or more operating parameters of the system 100 responsive to the one or more of these measurements. Without wishing to be bound by any particular theory, residual concentrations of hydrogen peroxide or ozone in water treated by the system 100 may be indicative of inefficient operation of one or more components of the system 100, such as the ozonation subsystem 104 or electrochemical cell 106 or may be indicative of excess production of the reagents, which poses a safety hazard and increases operating costs. In response to measured residual concentrations of hydrogen peroxide or ozone in water treated by the system 100, the controller can adjust one or more operating parameters of the system 100 including power applied to the electrochemical cell, power applied to the ozone generator, or a flow rate of the electrolyte through the electrochemical cell. The one or more operating parameters of the system 100 that are adjusted by the controller 101 in response to measurements from the one or more sensors 105 may include an amount of oxygen dissolved in the electrolyte and/or an amount of ozone dissolved in the ozonated water. Both of these adjustments can serve to modulate the concentration of hydroxide radicals generated in the mixing zone 108 during the peroxone process. In addition, the controller 101 can be configured to adjust one or both of a flow rate of hydrogen peroxide from the storage tank 110 or a flow rate of gaseous ozone from the source of ozone within the ozonation subsystem 104 based on one or more measured characteristics of the electrolyte or one or more characteristics of the ozonated water.

In some embodiments, the controller 101 is configured to introduce the ozonated water and hydrogen peroxide into the mixing zone 108 at a ratio of a concentration of the hydrogen peroxide to a concentration of the ozone of from about 10:1 to about 50:1. The choice to have hydrogen peroxide be in excess of ozone is based, in part, of the solubility of ozone in water, e.g., driven by Henry's Law, the costs of production, stability, and needs for storage. Ozone is unstable and made on demand, and in the systems disclosed herein, consumed by the excess of hydrogen peroxide during the peroxone process at a near unit conversion rate. In some embodiments, the ratio of a concentration of the hydrogen peroxide to a concentration of the ozone mixed is from about 10:1 to about 50:1, e.g., about 15:1 to about 45:1, about 20:1 to about 40): 1, about 25:1 to about 35:1, or about 30:1, e.g., about 10:1, about 15:1, about 20:1, about 25:1, about 30:1, about 35:1, about 40:1, about 45:1, or about 50:1.

The mixing zone 108 may include any suitable structural features constructed and arranged to mix the water, hydrogen peroxide, and ozone in the mixing zone 108 such as paddles, blades, aeration devices, sources of power, and other similar elements. The mixing zone 108 can be a suitably sized vessel, e.g., a tank, reactor, or the like, such as vessel 109 for a batch treatment process, that can contain the mixture of ozonated water and hydrogen peroxide in water and the water to be mixed with the mixture of ozonated water and hydrogen peroxide. In some embodiments, the mixing zone 108 is a separate vessel where the mixture of ozonated water and hydrogen peroxide is prepared using standard and controllable fluid connections, such as valves, flow sensors/flow meters, or other similar elements, by adjusting a rate of formation of the hydroxyl radicals in the water during the peroxone process.

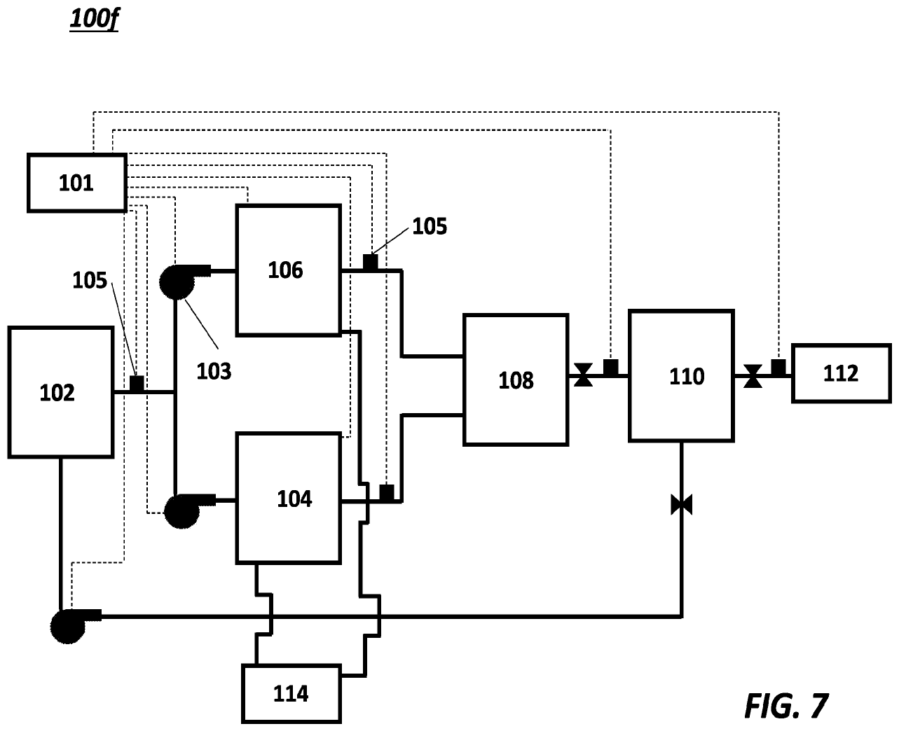

Further embodiments of systems for selectively removing one or more emergent compounds, e.g., 1,4-dioxane, from contaminated water are illustrated in FIGS. 7-9. In FIG. 7, system 100f includes a source of contaminated water 102 connectable to an inlet of an ozonation subsystem 104 including a source of ozone and an inlet of an electrochemical cell 106 co-located with the ozonation subsystem 104. Contaminated water from the source of water 102 can be distributed to the ozonation subsystem 104, the electrochemical cell 106, or other regions of the system 100f, 100g, and 100h using flow control devices such as pumps 103 and valves. An outlet of the ozonation subsystem 104 and an outlet of the electrochemical cell 106 are connectable to a first mixing zone 108 that is constructed and arranged to mix the ozonated water from the ozonation subsystem 104 and the hydrogen peroxide generated electrochemical cell 106 in to form the mixture of ozonated water and hydrogen peroxide.

With continued reference to FIGS. 7-9, the first mixing zone 108 and the second mixing zone 110 may include any suitable structural features constructed and arranged to mix the water in the first mixing zone 108 and second mixing zone 110, such as paddles, blades, aeration devices, sources of power, and other similar elements. One or both of the first mixing zone 108 and the second mixing zone 110 can be a suitably sized vessel, e.g., a tank, reactor, or the like, that can contain the mixture of ozonated water and hydrogen peroxide in water and the contaminated water to be mixed with the mixture of ozonated water and hydrogen peroxide. In some embodiments, each of the first mixing zone 108 and the second mixing zone 110 are separate vessels where an outlet of the vessel of the first mixing zone 108 is fluidly coupled to an inlet of the vessel of the second mixing zone 110, e.g., using standard and controllable fluid connections. For example, the fluid connections between the vessel of the first mixing zone 108 and the vessel of the second mixing zone 110 may include any structural elements that permit the controller 101 to adjust the dosing of the mixture of ozonated water and hydrogen peroxide mixed with the contaminated water, such as valves, flow sensors/flow meters, or other similar elements, by adjusting a rate of introduction of the mixture of ozonated water and hydrogen peroxide into the contaminated water. In certain embodiments, the first mixing zone and the second mixing zone are different zones with the same vessel. Each zone within the larger vessel may have independently controllable structural elements, operable by the controller 101, to permit the mixing of ozonated water and hydrogen peroxide and to dose the mixture of ozonated water and hydrogen peroxide into the contaminated water during the peroxone process, respectively. In this configuration, the first mixing zone and the second mixing zone in the larger vessel may be separated by any suitable partitioning scheme as described herein, such as by a solid divider with a fluidic connection, a permeable barrier, vertically oriented chambers, i.e., a spillway, or any other configuration constructed and arranged to separate the first mixing zone and the second mixing zone.

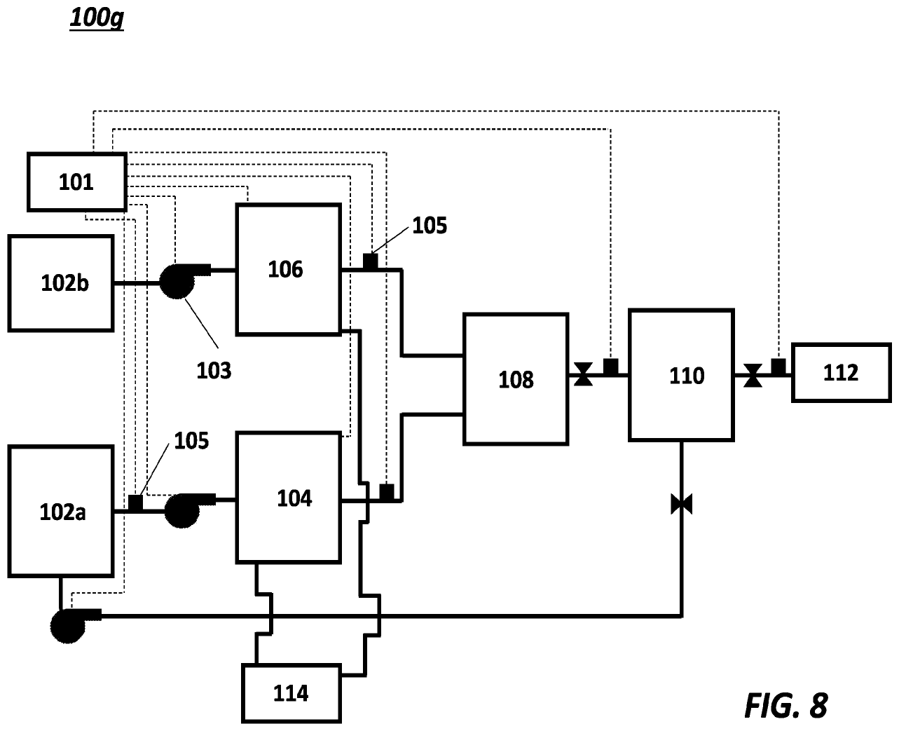

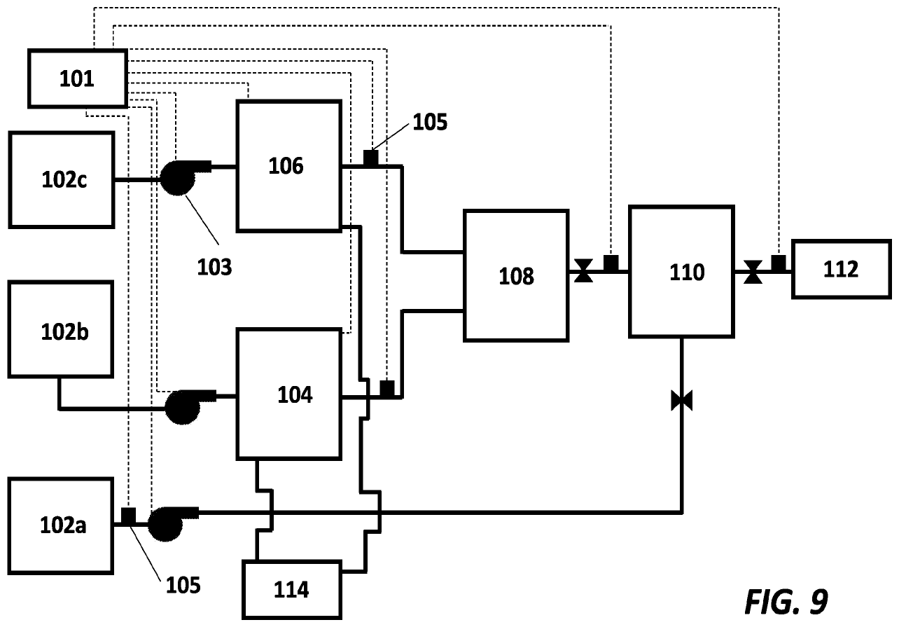

As illustrated in FIG. 7, in operation, contaminated water from the source of contaminated water 102 is directed to both of the ozonation subsystem 104 the electrochemical cell 106 to produce ozone to be dissolved in the contaminated water and hydrogen peroxide, respectively. In some embodiments, as illustrated in system 100g of FIG. 8, ozone may be produced by directing contaminated water from the source of contaminated water 102a into the ozonation subsystem and electrolyte from source of electrolyte 102b into the electrochemical cell 106. The source of electrolyte 102b may be a source of water separate from the source of contaminated water 102a. In a further alternate arrangement, such as that illustrated in system 100h of FIG. 9, the source of water to be treated 102a, the source of water 102b for the ozonation subsystem 104 and the source of water 102c, i.e., electrolyte, for the electrochemical cell 106 may all be separate sources of water. In any embodiment where the source of water for the ozonation subsystem 104 and electrochemical cell 106 are separate, the water may be a water treated with one or more treatment steps to improve its overall quality, such as one or more of carbon filtration, nanofiltration, reverse osmosis, ion exchange treatments, nanobead treatment, electrodeionization, or capacitive deionization. This disclosure is not limited by the source of electrolyte and any treatment processes used in its production.

With continued reference to FIGS. 7 and 8, the ozonation subsystem 104 includes a source of ozone that permits dissolution of the generated ozone into the contaminated water passing through the ozonation subsystem 104. The source of ozone within the ozonation subsystem 104 includes a source of oxygen 114 and one of a source of ultraviolet (UV) light or a source of voltage of sufficient power to form gaseous ozone in accordance with Eqs. 8-11 described herein. The source of ozone within the ozonation subsystem 104 further includes any structural elements needed to dissolve the generated ozone into the contaminated water, such as a pump, compressor, temperature control, or other related elements. The source of ozone within the ozonation subsystem 104 is not limited to the type of ozone generation or by the structural elements used to produce ozone. In some embodiments, the ozone is generated at a rate of about 1 gram of ozone per hour, which may be increased or decreased by adjusting the power delivered to the source of UV light or the source of voltage and/or adjusting the concentration of oxygen delivered from the source of oxygen 114. Similarly, contaminated water from the source of contaminated water 102 may be used as the electrolyte for the electrochemical cell 106 as illustrated in FIG. 7 or electrolyte from the source of electrolyte 102b as illustrated in FIG. 8 to generate hydrogen peroxide. As described herein, hydrogen peroxide is electrochemically generated in an electrochemical cell by the reduction of oxygen on the surface of an electrode, which may or may not be a catalytic process. The oxygen content of the contaminated water used as the electrolyte for the electrochemical cell 106 may be increased by the addition of oxygen from the source of oxygen 114. In some embodiments, the electrochemical cell 106 is constructed and arranged to produce hydrogen peroxide at a rate of about 6 g/hour, which may be increased or decreased by adjusting the power delivered to the electrochemical cell and/or adjusting the oxygen content of the electrolyte, for example, by adjusting the concentration or flow rate of oxygen delivered from the source of oxygen 114.

With continued reference to FIGS. 7 and 8, system 100f and 100g includes a controller 101 configured to control the mixing of ozonated water and hydrogen peroxide in the first mixing zone 108 and the treatment of the contaminated water including one or more emergent compounds present with the generated mixture of ozonated water and hydrogen peroxide in the second mixing zone 110 to form a treated water 112 by the peroxone process. In general, the controller 101 can adjust one or both of the reaction time of the peroxone process or a concentration of one or both of the hydrogen peroxide or the ozonated water introduced into the contaminated water based on a measured concentration of the one or more emergent compounds in the treated water.

As described herein, the concentration of ozone dissolved into the contaminated water can be adjusted by adjusting one or both of the concentration of dissolved oxygen in the contaminated water from the source of oxygen 114 and/or the power applied to the source of UV light or the source of voltage in the source of ozone within the ozonation subsystem 104. The concentration of hydrogen peroxide can be adjusted by the controller 101 by adjusting the power delivered to the electrochemical cell 106 and/or adjusting the concentration of dissolved oxygen delivered from the source of oxygen 114.

In some embodiments, the controller 101 is configured to introduce the ozonated water and hydrogen peroxide into the second mixing zone 110 at a ratio of a concentration of the hydrogen peroxide to a concentration of the ozone of from about 10:1 to about 50:1, e.g., about 15:1 to about 45:1, about 20:1 to about 40:1, about 25:1 to about 35:1, or about 30:1, e.g., about 10:1, about 15:1, about 20:1, about 25:1, about 30:1, about 35:1, about 40:1, about 45:1, or about 50:1, as described herein.

With continued reference to FIGS. 7 and 8, in some embodiments, the system 100f or 100g may include one or more sensors 105 positioned upstream or downstream of the one or more of the ozonation subsystem 104, electrochemical cell 106, first mixing zone 108, or second mixing zone 110. The one or more sensors 105 may include, as described herein, flow meters, water level sensors, conductivity meters, resistivity meters, chemical concentration meters, turbidity monitors, chemical species specific concentration sensors, temperature sensors, pH sensors, oxidation-reduction potential (ORP) sensors, pressure sensors, or any other sensor, probe, or scientific instrument useful for providing an indication of a desired characteristic or parameter of the contaminated water, ozonated water, hydrogen peroxide, or treated water entering or effluent exiting any one or more of the ozonation subsystem 104, electrochemical cell 106, first mixing zone 108, or second mixing zone 110. The one or more sensors 105 may be configured to collect data regarding the measured concentration of the one or more emergent compounds or a parameter indicative of the presence of the one or more emergent compounds according to a predetermined schedule. For example, the one or more sensors may be configured to collect data continuously or at intervals of minutes, such as every 1 minute, 2 minutes, 3 minutes, 4 minutes, 5 minutes, 6minutes, 7 minutes, 8 minutes, 9 minutes, 10) minutes, 20 minutes, 30 minutes, 40 minutes, 50 minutes, or 60 minutes. In some implementations, the one or more sensors 105 may be configured to collect data at intervals of hours, such as every 1 hour, 2 hours, 3 hours, 4 hours, 5 hours, 6 hours, 7 hours, 8 hours, 9 hours, 10 hours, 12 hours, 18 hours, or 24 hours. The data corresponding to the measured parameters that pertains to the concentration or presence of the one or more emergent compounds may be used by the controller 101 to adjust one or more operational parameters of the system.

In a non-limiting example for water contaminated by, 1,4-dioxane, a heterocyclic carbon compound commonly used as an industrial feedstock classified as an emergent compound, a sensor may be deployed to measure a concentration of a species that is representative of a concentration of the 1,4-dioxane in the water. Without wishing to be bound by any particular theory, an in-line measurement of the concentration of 1,4-dioxane could be within the measurement of a concentration of TOC making the concentration of 1,4-dioxane difficult to resolve from the background. A sensor for this purpose may be constructed and arranged to measure a surrogate species known to be representative of the presence of 1,4-dioxane. In some embodiments, measurements of the concentration of 1,4-dioxane can be taken away from the system, such as by titrimetric or chromatographic measurements. This example is non-limiting, and this methodology can be used without limitation on other types of compounds, both emergent and non.

The controller 101 of any system embodiment described herein may be implemented using one or more computer systems. The computer system may be, for example, a general-purpose computer such as those based on an Intel CORE®-type processor, an Intel XEON®-type processor, an Intel CELERON®-type processor, an AMD FX-type processor, an AMD RYZEN®-type processor, an AMD EPYC®-type processor, and AMD R-series or G-series processor, or any other type of processor or combinations thereof. Alternatively, the computer system may include programmable logic controllers (PLCs), specially programmed, special-purpose hardware, for example, an application-specific integrated circuit (ASIC) or controllers intended for analytical systems. In some embodiments, the controller 101 may be operably connected to or connectable to a user interface constructed and arranged to permit a user or operator to view relevant operational parameters of the system 100a-100h, adjust said operational parameters, and/or stop operation of the system 100a-100h as needed. The user interface may include a graphical user interface (GUI) that includes a display configured to be interacted with by a user or service provider and output status information of the system 100a-100h.

The controller 101 of any system embodiment described herein can include one or more processors typically connected to one or more memory devices, which can comprise, for example, any one or more of a disk drive memory, a flash memory device, a RAM memory device, or other device for storing data. The one or more memory devices can be used for storing programs and data during operation of the system 100a-100h. For example, the memory device may be used for storing historical data relating to one or more of the parameters measured by the sensors over a period of time. Software, including programming code that implements embodiments disclosed herein, can be stored on a computer readable and/or writeable nonvolatile recording medium, and then typically copied into the one or more memory devices wherein it can then be executed by the one or more processors. Such programming code may be written in any of a plurality of programming languages, for example, ladder logic, Python, Java, Swift, Rust, C, C#, or C++, G, Eiffel, VBA, or any of a variety of combinations thereof.

The system for treating water may be constructed and arranged to operate in a continuous flow process or as a batch process, and the mode of operation may determine the structural elements present in the system. For a continuous flow process, there is generally no long-term storage of reagents, i.e., ozonated water and hydrogen peroxide, and the reagents for treating contaminated water are generated on demand and continuously as contaminated water is directed through the system. For a continuous treatment process, the mixture of hydrogen peroxide and ozone is dosed into the water to be treated at an adjustable rate by the controller. The dosing rate of the mixture of hydrogen peroxide and ozone is generally a function of the measured concentrations of one or more species, e.g., one or more contaminants, e.g., one or more emergent compounds, present in the water to be treated and may track linearly with the measured concentration a specific species or group or class of species, e.g., the dosing rate is increased with increasing concentration and decreased with decreasing concentration. In a batch process as described herein, reagents, i.e., ozonated water and hydrogen peroxide, are generated and stored, then used form a volume of mixed hydrogen peroxide and ozonated water which is used to treat a volume of water by the peroxone process. In this configuration, the mixing zone is a vessel or a separated mixing zone within a vessel and a volume of mixed hydrogen peroxide and ozonated water is formed. This volume of mixed hydrogen peroxide and ozonated water is mixed with a volume of water to be treated to form a volume of treated water. The controller of the system may be configured to dose the volume of mixed hydrogen peroxide and ozonated water at a rate or period that is sufficient to treat the one or more contaminants, e.g., one or more emergent compounds, present in the water. Once the treated water is formed, it can be discharged, and the batch process repeated to form additional treated water.

Treatment strategies for removing contaminants, such as emergent compounds, from contaminated water generally fall into two primary philosophies. The first is to overdose or overshoot the precise amount of chemicals, i.e., hydrogen peroxide and ozone for the peroxone process, required to account for variability or fluctuations in contaminant or emergent compound concentrations, ensuring there is a below specification level of one or more of the contaminants or emergent compounds present at a downstream process. This approach often results in increased cost to a service provider or end user due to excessive production of ozone and hydrogen peroxide for the peroxone process. Alternatively, in the second dosing philosophy, hydrogen peroxide and ozonated water precursors may be slightly underfed while maintaining contaminant or emergent compound concentrations at a level that is approximate or near the upper threshold specified by a regulatory authority. This second philosophy may lead to intermittent instances where the measured contaminant or emergent compound concentration exceeds regulatory thresholds, requiring action from the service provider or end user. Aspects and embodiments disclosed herein may provide for accurate dosing of hydrogen peroxide and ozonated water to selectively remove one or more emergent compounds from contaminated water having high background TOC concentration without wasteful use of resources.

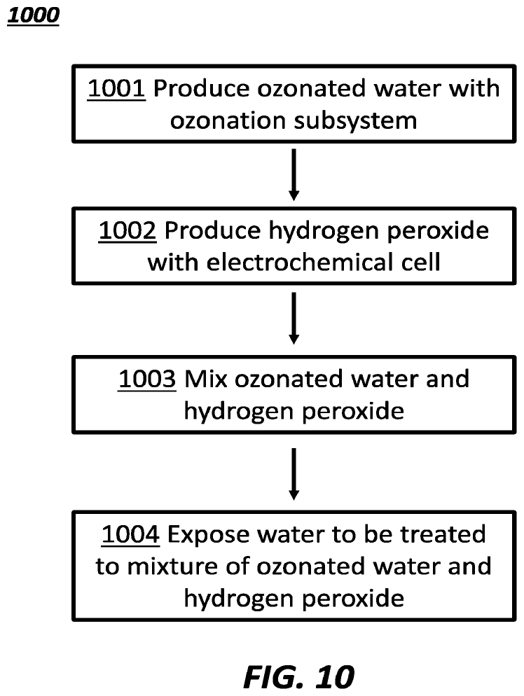

In accordance with an aspect, there is provided a method of treating water 1000, illustrated in FIG. 10. The method 1000 may include producing ozonated water with an ozonation subsystem including a source of ozone configured to dissolve ozone into water from a source of water as described herein at step 1001. The method 1000 may include producing hydrogen peroxide in an electrochemical cell that is co-located with the source of ozone and configured to produce hydrogen peroxide from electrolyte from the source of electrolyte as described herein at step 1002. The electrochemical cell may have an inlet connectable to a source of electrolyte and an outlet. The method 1000 further may include mixing the ozonated water and hydrogen peroxide at step 1003. The mixing of the ozonated water and hydrogen peroxide may occur in a mixing zone as described herein. The method 1000 additionally may include exposing water to be treated to the mixture of the ozonated water and hydrogen peroxide at step 1004.

In some embodiments, both the water provided to the ozonation subsystem and the electrolyte may be provided from a source of the water to be treated.

In further embodiments, the method of treating water may include fluidically connecting the source of electrolyte to the inlet of the electrochemical cell and fluidically connecting the outlet of the electrochemical cell to the ozonation subsystem, i.e., operation in a continuous flow process, e.g., as illustrated in FIG. 3.

In further embodiments, the method of treating water may include providing the ozonated water from the ozonation subsystem to water to be treated through a first conduit that provides the hydrogen peroxide from the electrochemical cell to the water to be treated through a second conduit. In the method of treating water, the method further may include flowing the water to be treated from a source of the water to be treated through a third conduit including a first inlet coupled to an outlet of the ozonation subsystem configured to receive the ozonated water and a second inlet coupled to the outlet of the electrochemical cell constructed and arranged to receive the hydrogen peroxide from the electrochemical cell. In some embodiments, the ozonated water may be introduced into the water to be treated upstream of a point of introduction of the hydrogen peroxide into the water to be treated. Alternatively, the ozonated water may be introduced into the water to be treated downstream of a point of introduction of the hydrogen peroxide into the water to be treated.

In some embodiments, the water to be treated may be treated with the mixture of the ozonated water and hydrogen peroxide in a batch mode treatment process as described herein.

In further embodiments, the method of treating water may include fluidically coupling the outlet of the electrochemical cell to a point of introduction in a conduit fluidically coupling the source of electrolyte to the inlet of the electrochemical cell, e.g., as illustrated in FIG. 2. In further embodiments, the method of treating water may include dissolving oxygen into water to form oxygenated water as the electrolyte. The dissolving of the oxygen into water to form the oxygenated water may include saturating the oxygenated water with oxygen, e.g., under pressure, decreased temperature, or mixing conditions. In certain embodiments, the method of treating water may include dissolving sufficient ozone into the water such that the ozonated water is saturated with ozone.

In further embodiments, the method of treating water may include measuring a concentration of one or more contaminants, e.g., one or more emergent compounds in an aqueous solution passing through the system at one of an inlet, i.e., at the source of contaminated water, or an outlet of the system, e.g., using one or more sensors positioned at a source of water to be treated or at a treated water outlet. In further embodiments, the method of treating water may include adjusting one or more operating parameters of the system responsive to a measured concentration of the one or more contaminants. In some embodiments, the one or more parameters to be adjusted may include one or more of power applied to the electrochemical cell, power applied to the ozone generator, or a flow rate of the electrolyte trough the electrochemical cell. In certain embodiments, the one or more operating parameters of the system may include an amount of oxygen dissolved in the electrolyte. In further embodiments, the one or more operating parameters of the system includes an amount of ozone dissolved in the ozonated water.

In further embodiments, the method of treating water may include adjusting one or more operating parameters of the system responsive to a measured concentration of one of residual hydrogen peroxide or residual ozone in water treated by the system. For example, the one or more operating parameters of the system to be adjusted responsive to the measured concentration of the one of residual hydrogen peroxide or residual ozone may include one or more of power applied to the electrochemical cell, power applied to the ozone generator, or a flow rate of the electrolyte through the electrochemical cell. In certain embodiments, the one or more operating parameters of the system may include an amount of oxygen dissolved in the electrolyte or an amount of ozone dissolved in the ozonated water.

In further embodiments, the method of treating water may include delivering the hydrogen peroxide to a storage tank fluidically coupled to the outlet of the electrochemical cell. In further embodiments, the method of treating water may include adjusting one of a flow rate of hydrogen peroxide from the storage tank or a flow rate of gaseous ozone from the source of ozone based on one or more measured characteristics of the electrolyte or one or more characteristics of the ozonated water.

In accordance with an aspect, there is provided a method of selectively removing one or more emergent compounds from contaminated water. The method may include providing contaminated water comprising a first concentration of one or more emergent compounds. The method may include electrochemically generating an aqueous solution of hydrogen peroxide and generating an aqueous solution of ozone. The method may include mixing the aqueous solution of hydrogen peroxide and the aqueous solution of ozone with the contaminated water to oxidize at least a portion of the one or more emergent compounds in a peroxone process to produce a treated water. The method further may include determining a second concentration of the one or more emergent compounds in the treated water. The method additionally may include adjusting one or more of a reaction time of the peroxone process, a concentration of hydrogen peroxide in the aqueous solution of hydrogen peroxide, and/or a concentration of ozone in the aqueous solution of ozone introduced into the contaminated water based on the second concentration of the one or more emergent compounds.

In some embodiments, selectively removing the one or more emergent compounds includes removing one or more heterocyclic organic compounds. For example, the one or more heterocyclic organic compounds may include one or more heterocyclic ethers, such as 1,4-dioxane. Thus, in certain embodiments, selectively removing the one or more emergent compounds may include selectively removing 1,4-dioxane. In specific embodiments, providing the contaminated water may include providing contaminated water having a first concentration of less than 100 ppm 1,4-dioxane. The first concentration may be less than 100 ppm, e.g., less than 100 ppm, 95 ppm, 90 ppm, 85 ppm, 80 ppm, 75 ppm, 70 ppm, 65 ppm, 60 ppm, 55 ppm, 50 ppm, 45 ppm, 40 ppm, 35 ppm, 30 ppm, 25 ppm, 20 ppm, 15 ppm, 10 ppm, 9 ppm, 8 ppm, 7 ppm, 6 ppm, 5 ppm, 4 ppm, 3 ppm, 2 ppm, or 1 ppm. The contaminated water further may include one or more additional organic components having an elevated total organic carbon (TOC) background. The one or more additional organic components may be present at a concentration higher than 100 ppm. For example, the one or more additional organic components may be present at a concentration higher than 100 ppm, 150 ppm, 200 ppm, 250 ppm, 300 ppm, 350 ppm, 400 ppm, 450 ppm, 500 ppm, 550 ppm, 600 ppm, 650 ppm, 700 ppm, 750 ppm, 800 ppm, 850 ppm, 900 ppm, 950 ppm, or 1000 ppm, or more.

In certain embodiments, the step of adjusting may include adjusting to control the second concentration of the one or more emergent compounds to be below a predetermined concentration.

The hydrogen peroxide may be generated electrochemically in an electrochemical cell from an electrolyte by the reduction of oxygen in the electrolyte. The electrolyte may be generated by dissolving oxygen in an aqueous solution, such as in the contaminated water. The oxygen dissolved in the contaminated water may be sourced from a source of oxygen. In certain embodiments, the ozone used to produce the ozonated aqueous solution may be generated using a source of oxygen and one of a source of voltage or a source of ultraviolet (UV) light. In further embodiments, the method may include generating the ozonated aqueous solution by dissolving the generated ozone in an aqueous solution, such as the contaminated water. In further embodiments, the method may include generating the ozonated aqueous solution in an ozonation subsystem co-located with the electrochemical cell. Mixing the ozonated aqueous solution with the hydrogen peroxide generated using the electrochemical cell may be performed to generate hydroxyl radicals as part of the peroxone process.

Adjusting the concentration of ozone, for example, may include increasing or decreasing the concentration of oxygen used to generate ozone, e.g., by high voltage or corona discharge or UV light, or adjusting the power applied to a source of UV light. In some embodiments, adjusting the concentration of the hydrogen peroxide may include one or both of adjusting a concentration of dissolved oxygen in the electrolyte or adjusting the power applied to the electrochemical cell.

In some embodiments, the method of selectively removing one or more emergent compounds from contaminated water may be performed as a continuous flow process. In other embodiments, the method of selectively removing one or more emergent compounds from contaminated water may be performed as a batch process, e.g., by producing and storing ozonated water and hydrogen peroxide, forming a volume of mixed ozonated water and hydrogen peroxide, and dosing a volume of the contaminated water with the volume of mixed ozonated water and hydrogen peroxide to form a treated water by the peroxone process.

In some embodiments, the predetermined time for the advanced oxidation process on the contaminated water is two (2) hours or less, e.g., less than 2 hours, less than 1.5 hours, less than 1 hour, less than 30 minutes, less than 25 minutes, less than 20 minutes, less than 15 minutes, or less than 10 minutes.

### EXAMPLES

The function and advantages of these and other embodiments can be better understood from the following examples. These examples are intended to be illustrative in nature and are not considered to be in any way limiting the scope of the invention.

### Example 1—Electrochemical Generation of H₂O₂

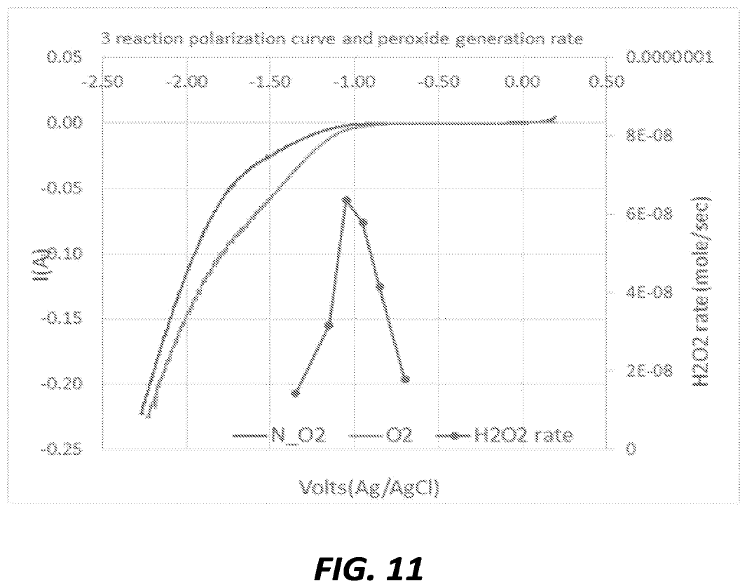

FIG. 11 illustrates the current-voltage characteristic curves for the production of hydrogen peroxide using the electrochemical cell and the rate of hydrogen peroxide production (in moles/second). As is seen in FIG. 11, there are three distinct cathodic reaction stages as voltage is applied to the cathode to start the two electron reduction of water. The production of hydrogen peroxide crosses a maximum rate when at the transition from a linear current increase to the saturation current, followed by a sharp drop in rate at sustained current saturation.

### Example 2—Electrochemical Reduction of 1,4-dioxane

In this Example, the efficacy of an electrochemical advanced oxidation process (EAOP) on the removal of dissolved 1,4-dioxane was evaluated.

In a beaker, 2 L of an aqueous solution of 1,4-dioxane in an elevated background of TOC was prepared. Samples of this aqueous solution were analyzed for TOC and analyzed by GC-MS for the concentration of 1,4-dioxane. The starting concentration of 1,4-dioxane was about 16 ppm and the background TOC had a concentration of about 425 ppm. The aqueous solution was electrochemically treated in an electrochemical cell with a Magneli phase Ti₄O₇ electrode and a mixed metal oxides (MMO) electrode. Use of both of the Magneli phase Ti₄O₇ electrode and the MMO electrode for the same treatment process showed that there was no significant difference in the resultant performance compared to the use of a platinum anode and cathode. The anodic electrode surface area was measured to be ˜150 cm². During the experiment, the current applied to the electrode was 4.4 A for a current density of ˜293 A/m². During the electrolysis reaction, about 10 mL of an aqueous solution of 30% H₂O₂ was added to the beaker in five equal volume increments during the duration of the experiment, i.e., 300 minutes.

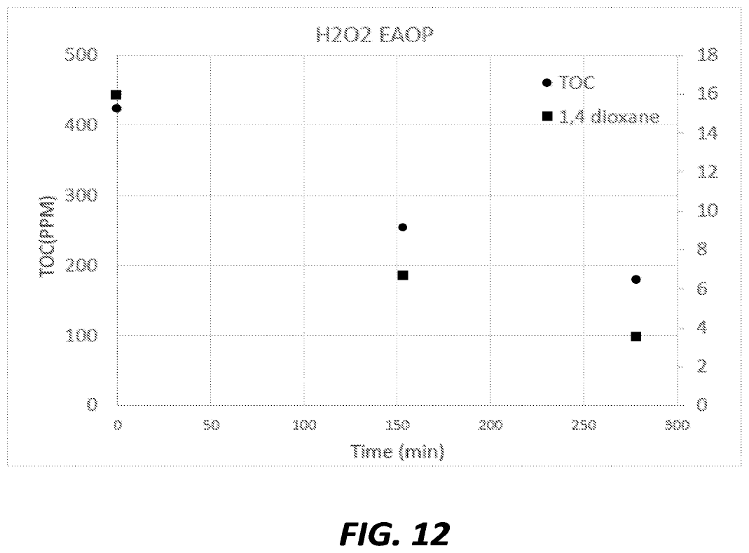

The resulting TOC data and the 1,4-dioxane data are presented in FIG. 12. As illustrated, both of the TOC (dots) and 1,4-dioxane (squares) decreased during the experiment at approximately the same rate of destruction, indicating that the electrochemical AOP using H₂O₂ is a non-selective method for the removal of 1,4-dioxane from contaminated water.

### Example 3—Peroxone and EAOP Reduction of 1,4-dioxane

In this Example, the efficacy of a hybrid treatment process using a peroxone process and an EAOP on the removal of dissolved 1,4-dioxane was evaluated.

In a beaker, 2 L of an aqueous solution of 1,4-dioxane in an elevated background of TOC was prepared. The starting concentration of 1,4-dioxane was about 12 ppm and the background TOC had a concentration of about 350 ppm. The aqueous solution was electrochemically treated using an electrochemical cell with a RUA_Cl electrode at an average current density of about 800 A/m². During electrolysis, an aqueous solution of 30% H₂O₂ was added to the beaker according to the time schedule shown in Table 1. Gaseous ozone (O₃) was delivered continuously during the experiment at a rate of 1 g/hour using a porous dispenser with a bubble size visually assessed at of 1-2 mm. The RUA_Cl electrode material was demonstrated to have comparable activity to the Magneli phase Ti₄O₇ electrode and the MMO electrode used in Example 2.

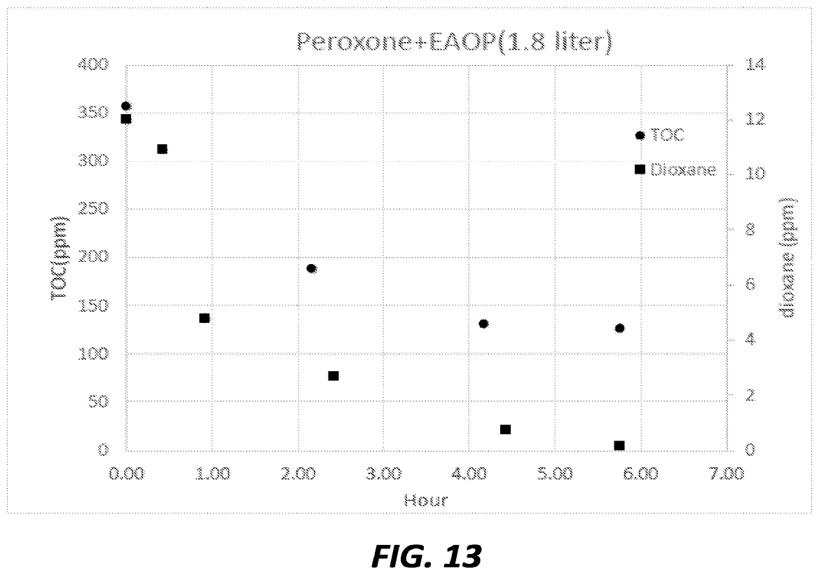

The resulting TOC data and the 1,4-dioxane data are presented in FIG. 13. As illustrated, both of the TOC (dots) and 1,4-dioxane (squares) decreased during the experiment. The rate of TOC destruction was greater than that for 1,4-dioxane and the TOC concentration went to zero during the duration of the experiment, i.e., in about 6 hours, indicating that the electrochemical AOP using H₂O₂ is a non-selective method for the removal of 1,4-dioxane from contaminated water and is suited for overall TOC removal.

TABLE 1
Addition schedule for H₂O₂ during the
experiment of Example 2

| | | | | | |
|---|---|---|---|---|---|
| Time (hr) | 0 | 0.75 | 2.5 | 3.7 | 4.5 |
| Vol. (mL) | 15 | 5 | 1 | 2 | 1 |

### Example 4—Peroxone Reduction of 1,4-dioxane

In this Example, the efficacy of a treatment process using peroxone on the removal of dissolved 1,4-dioxane was evaluated.

In a beaker, 2 L of an aqueous solution of 1,4-dioxane in an elevated background of TOC was prepared. Samples of this aqueous solution were analyzed for TOC and analyzed by GC-MS for the concentration of 1,4-dioxane. The starting concentration of 1,4-dioxane was about 12 ppm and the background TOC had a concentration of about 350 ppm. Gaseous ozone (O₃) was delivered continuously during the experiment at a rate of 1 g/hour using a porous dispenser with a bubble size visually assessed at of 1-2 mm. During the experiment, about 10 mL of an aqueous solution of 30% H₂O₂ was added to the beaker in five equal volume increments during the duration of the experiment.

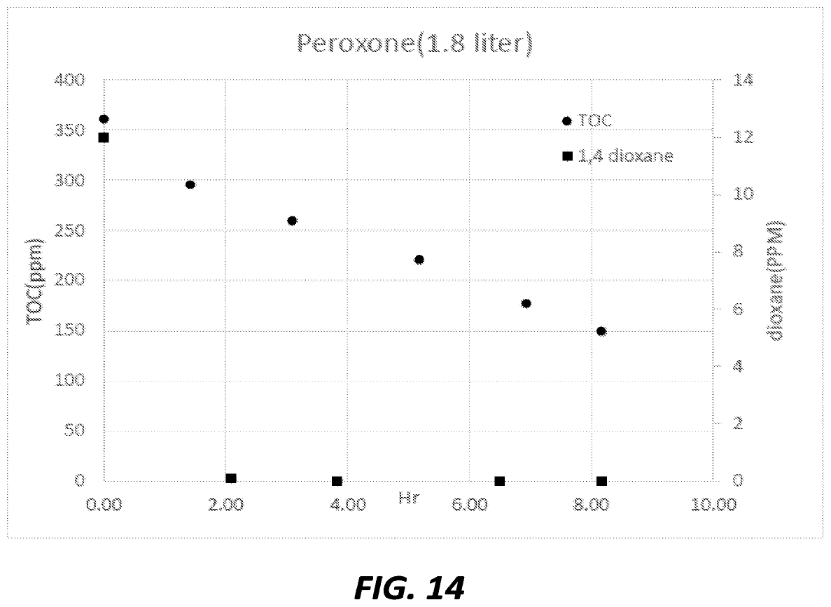

The resulting TOC data and the 1,4-dioxane data are presented in FIG. 14. As illustrated, both of the TOC (dots) and 1,4-dioxane (squares) decreased during the experiment. The rate of 1,4-dioxane destruction was far greater than that for the TOC, with the 1,4-dioxane concentration went to zero during the duration of the experiment, i.e., within about 2 hours and the TOC concentration reduced by about 20% for a selectivity ratio of 5:1. This indicated that the peroxone process is a selective method for the removal of 1,4-dioxane from contaminated water.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A water treatment system comprising:
an ozonation subsystem including a source of ozone configured to dissolve ozone into water from a source of water to produce ozonated water:
an electrochemical cell co-located with the ozonation subsystem, having an inlet connectable to a source of electrolyte, configured to produce hydrogen peroxide from electrolyte from the source of electrolyte, and having an outlet; and
a mixing zone configured to receive the ozonated water, to receive the hydrogen peroxide from the outlet of the electrochemical cell, and to form a mixture of the ozonated water and hydrogen peroxide.

2. The system of claim 1, wherein the source of water and source of electrolyte are the same source, the same source being a source of water to be treated.

3. The system of claim 1, further comprising a first conduit fluidically connecting the source of electrolyte to the inlet of the electrochemical cell and a second conduit fluidically connecting the outlet of the electrochemical cell to the ozonation subsystem.

4. The system of claim 1, further comprising a first conduit configured to provide the ozonated water from the ozonation subsystem to water to be treated and a second conduit configured to provide the hydrogen peroxide from the electrochemical cell to the water to be treated.

5. The system of claim 4, further comprising a third conduit configured to flow the water to be treated from a source of the water to be treated and including a first inlet coupled to an outlet of the ozonation subsystem configured to receive the ozonated water and a second inlet coupled to the outlet of the electrochemical cell and configured to receive the hydrogen peroxide from the electrochemical cell.

6. The system of claim 5, wherein the first inlet is upstream of the second inlet.

7. The system of claim 5, wherein the second inlet is upstream of the first inlet.

8. The system of claim 5, wherein the third conduit further comprises a product water outlet downstream of the first and second inlets.

9. The system of claim 4, wherein both the first conduit and the second conduit are fluidically coupled to a vessel in which water to be treated is mixed with the mixture of the ozonated water and hydrogen peroxide in a batch mode treatment process.

10. The system of claim 1, wherein the outlet of the electrochemical cell is fluidically coupled to a point of introduction in a conduit fluidically coupling the source of electrolyte to the inlet of the electrochemical cell.

11. The system of claim 1, wherein the source of electrolyte is a source of oxygenated water.

12. The system of claim 11, wherein the source of electrolyte includes a source of oxygen and a mixer configured to receive water and oxygen from the source of oxygen and to dissolve the oxygen into the water.

13. The system of claim 11, wherein the mixer is configured to saturate the oxygenated water with oxygen.

14. The system of claim 1, wherein the ozonation subsystem is configured to dissolve sufficient ozone into the water such that the ozonated water is saturated with ozone.

15. The system of claim 1, further comprising a sensor configured to measure a concentration of one or more contaminants in an aqueous solution passing through the system, the sensor positioned at one of an inlet or an outlet of the system.

16. The system of claim 15, further comprising a controller in communication with the sensor and configured to adjust one or more operating parameters of the system responsive to a measured concentration of the one or more contaminants.

17. The system of claim 16, where the one or more operating parameters of the system include one or more of power applied to the electrochemical cell, power applied to the ozone generator, or a flow rate of the electrolyte trough the electrochemical cell.

18. The system of claim 16, where the one or more operating parameters of the system includes an amount of oxygen dissolved in the electrolyte.

19. The system of claim 1, further comprising a sensor configured to measure a concentration of one of residual hydrogen peroxide or residual ozone in water treated by the system.

20. The system of claim 19, further comprising a controller in communication with the sensor and configured to adjust one or more operating parameters of the system responsive to a measured concentration of the one of residual hydrogen peroxide or residual ozone.

21. The system of claim 20, where the one or more operating parameters of the system include one or more of power applied to the electrochemical cell, power applied to the ozone generator, or a flow rate of the electrolyte trough the electrochemical cell.

22. The system of claim 20, where the one or more operating parameters of the system includes an amount of oxygen dissolved in the electrolyte.

23. The system of claim 20, where the one or more operating parameters of the system includes an amount of ozone dissolved in the ozonated water.

24. The system of claim 1, further comprising a storage tank fluidically coupled to the outlet of the electrochemical cell.

25. The system of claim 24, further comprising a controller configured to adjust one or both of a flow rate of hydrogen peroxide from the storage tank or a flow rate of gaseous ozone from the source of ozone based on one or more measured characteristics of the electrolyte or one or more characteristics of the ozonated water.

26. The system of claim 1, further comprising a controller configured to control a ratio of hydrogen peroxide to ozone received in the mixing zone to between about 10:1 and about 50:1.

27. A method of treating water, the method comprising:
producing ozonated water with an ozonation subsystem including a source of ozone configured to dissolve ozone into water from a source of water:
producing hydrogen peroxide in an electrochemical cell co-located with the source of ozone, having an inlet connectable to a source of electrolyte, configured to produce hydrogen peroxide from electrolyte from the source of electrolyte, and having an outlet; and
mixing the ozonated water and hydrogen peroxide to form a mixture of the ozonated water and hydrogen peroxide in a mixing zone: and
exposing water to be treated to the mixture of the ozonated water and hydrogen peroxide in a peroxone process.

28. The method of claim 27, wherein both water provided to the ozonation subsystem and the electrolyte are provided from a source of the water to be treated.

29. The method of claim 27, further comprising fluidically connecting the source of electrolyte to the inlet of the electrochemical cell and fluidically connecting the outlet of the electrochemical cell to the ozonation subsystem.

30. The method of claim 27, further comprising providing the ozonated water from the ozonation subsystem to water to be treated through a first conduit providing the hydrogen peroxide from the electrochemical cell to the water to be treated through a second conduit.

31. The method of claim 30, further comprising flowing the water to be treated from a source of the water to be treated through a third conduit including a first inlet coupled to an outlet of the ozonation subsystem configured to receive the ozonated water and a second inlet coupled to the outlet of the electrochemical cell and configured to receive the hydrogen peroxide from the electrochemical cell.

32. The method of claim 31, wherein the ozonated water is introduced into the water to be treated upstream of a point of introduction of the hydrogen peroxide in to the water to be treated.

33. The method of claim 31, wherein the ozonated water is introduced into the water to be treated downstream of a point of introduction of the hydrogen peroxide in to the water to be treated.

34. The method of claim 30, wherein the water to be treated is treated with the mixture of the ozonated water and hydrogen peroxide in a batch mode treatment process.

35. The method of claim 27, further comprising fluidically coupling the outlet of the electrochemical cell to a point of introduction in a conduit fluidically coupling the source of electrolyte to the inlet of the electrochemical cell.

36. The method of claim 27, further comprising dissolving oxygen into water to form oxygenated water as the electrolyte.

37. The method of claim 36, further comprising saturating the oxygenated water with oxygen.

38. The method of claim 27, further comprising dissolving sufficient ozone into the water such that the ozonated water is saturated with ozone.

39. The method of claim 27, further comprising measuring a concentration of one or more contaminants in an aqueous solution passing through the system at one of an inlet or an outlet of the system.

40. The method of claim 39, further comprising adjusting one or more operating parameters of the system responsive to a measured concentration of the one or more contaminants.

41. The method of claim 40, where the one or more operating parameters of the system include one or more of power applied to the electrochemical cell, power applied to the ozone generator, or a flow rate of the electrolyte trough the electrochemical cell.

42. The method of claim 40, where the one or more operating parameters of the system includes an amount of oxygen dissolved in the electrolyte.

43. The method of claim 27, further comprising measuring a concentration of one of residual hydrogen peroxide or residual ozone in water treated by the system.

44. The method of claim 43, further comprising adjusting one or more operating parameters of the system responsive to a measured concentration of the one of residual hydrogen peroxide or residual ozone.

45. The method of claim 44, where the one or more operating parameters of the system include one or more of power applied to the electrochemical cell, power applied to the ozone generator, or a flow rate of the electrolyte trough the electrochemical cell.

46. The method of claim 44, where the one or more operating parameters of the system includes an amount of oxygen dissolved in the electrolyte.

47. The method of claim 44, where the one or more operating parameters of the system includes an amount of ozone dissolved in the ozonated water.

48. The method of claim 27, further comprising delivering the hydrogen peroxide to a storage tank fluidically coupled to the outlet of the electrochemical cell.

49. The method of claim 48, further comprising adjusting one of a flow rate of hydrogen peroxide from the storage tank or a flow rate of gaseous ozone from the source of ozone based on one or more measured characteristics of the electrolyte or one or more characteristics of the ozonated water.

50. A method of selectively removing one or more emergent compounds from contaminated water, the method comprising:
providing contaminated water comprising a first concentration of one or more emergent compounds:
electrochemically generating an aqueous solution of hydrogen peroxide:
generating an aqueous solution of ozone:
mixing the aqueous solution of hydrogen peroxide and the aqueous solution of ozone with the contaminated water to oxidize at least a portion of the one or more emergent compounds in a peroxone process and produce a treated water:
determining a second concentration of the one or more emergent compounds in the treated water; and
adjusting one or more of a reaction time of the peroxone process, a concentration of hydrogen peroxide in the aqueous solution of hydrogen peroxide, or a concentration of ozone in the aqueous solution of ozone introduced into the contaminated water based on the second concentration of the one or more emergent compounds.

51. The method of claim 50, wherein selectively removing the one or more emergent compounds includes removing one or more heterocyclic organic compounds.

52. The method of claim 51, wherein selectively removing the one or more heterocyclic organic compounds in the contaminated water includes removing at least one heterocyclic ether.

53. The method of claim 52, wherein selectively removing the at least one heterocyclic ether includes removing at least 1,4-dioxane.

54. The method of any one of claims 50-53, wherein the step of adjusting comprises adjusting to control the second concentration of the one or more emergent compounds to be below a predetermined concentration.

55. The method of claim 53, wherein providing the contaminated water includes providing contaminated water having a first concentration of less than 100 ppm 1,4-dioxane.

56. The method of claim 55, wherein providing the contaminated water includes providing contaminated water having a first concentration of less than 100 ppm 1,4-dioxane and one or more additional organic contaminants.

57. The method of claim 56, wherein providing the contaminated water includes providing contaminated water having a first concentration of less than 100 ppm 1,4-dioxane and total organic contaminants at a concentration higher than 100 ppm.

58. The method of claim 50, wherein electrochemically generating the hydrogen peroxide includes generating hydrogen peroxide in an electrochemical cell from an electrolyte.

59. The method of claim 58, further comprising generating the electrolyte by dissolving oxygen in an aqueous solution.

60. The method of claim 59, further comprising generating the electrolyte by dissolving oxygen in the contaminated water.

61. The method of claim 50, wherein ozone used to produce the aqueous solution of ozone is generated using a source of oxygen and one of a source of voltage or a source of ultraviolet light.

62. The method of claim 61, further comprising generating the aqueous solution of ozone by dissolving ozone in an aqueous solution.

63. The method of claim 62, further comprising generating the ozonated aqueous solution by dissolving ozone in the contaminated water.

64. The method of claim 61, further comprising generating the ozonated aqueous solution in an ozonation subsystem co-located with the electrochemical cell.

65. The method of claim 58, wherein adjusting the concentration of the aqueous solution of hydrogen peroxide includes one or both of adjusting a concentration of dissolved oxygen in the electrolyte or adjusting power applied to the electrochemical cell.

66. The method of claim 50, performed as a continuous flow process.

67. The method of claim 50, performed as a batch process.

68. The method of claim 50, wherein the reaction time is two hours or less.

69. A system for selectively removing one or more emergent compounds from contaminated water, the system comprising:
an ozonation subsystem including a source of ozone configured to dissolve ozone into water from a source of water to produce ozonated water;
an electrochemical cell co-located with the ozonation subsystem, having an inlet connectable to a source of electrolyte, configured to produce hydrogen peroxide from electrolyte from the source of electrolyte, and having an outlet:
a first mixing zone configured to receive the ozonated water and the hydrogen peroxide from the outlet of the electrochemical cell and to mix the ozonated water and hydrogen peroxide: and
a second mixing zone configured to receive and mix the mixture of hydrogen peroxide and ozone and at least the one or more emergent compounds in the contaminated water by a peroxone process to form a treated water.

70. The system of claim 69, wherein the source of water is a source of the contaminated water.

71. The system of claim 69, wherein the source of electrolyte is a source of the contaminated water.

72. The system of claim 69, further comprising a controller configured to adjust one or both of the reaction time of the peroxone process or a concentration of one or both of the hydrogen peroxide or the ozonated water introduced into the contaminated water based on a measured concentration of the one or more emergent compounds in the treated water.

73. The system of claim 72, wherein the controller is further configured to adjust the concentration of the hydrogen peroxide by one of adjusting a concentration of dissolved oxygen in the electrolyte or adjusting power applied to the electrochemical cell.

74. The system of claim 69, further comprising a controller configured to introduce the ozonated water and hydrogen peroxide into first mixing zone at a ratio of a concentration of the hydrogen peroxide to a concentration of the ozone of from about 10:1 to about 50:1.

75. The system of claim 69, configured to treat the contaminated water in a continuous flow process, wherein the controller is further configured to adjust a rate of introduction of the hydrogen peroxide and ozone into the contaminated water during the peroxone process.

76. The system of claim 69, wherein the first mixing zone includes a vessel configured to hold a volume of the hydrogen peroxide and a volume of the ozonated water and dose the mixture of the hydrogen peroxide and ozonated water into the second mixing zone at a rate or period controlled by a controller of the system.

77. The system of claim 69, wherein the second mixing zone includes a vessel and the system is configured to form the treated water by reacting the mixture of the hydrogen peroxide and ozonated water and the contaminated water in a batch process in the vessel.

75. The system of claim 69, wherein the first mixing zone and the second mixing zone are different zones with a same vessel.
